(19) United States
(12) Patent Application Publication
(10) Pub. No.: US 2025/0330957 A1
(43) Pub. Date: Oct. 23, 2025

(54) COMMUNICATION CONFIGURATIONS FOR REDUCED POWER CONSUMPTION

(71) Applicant: QUALCOMM Incorporated, San Diego, CA (US)

(72) Inventors: Gabi SARKIS, San Diego, CA (US); Kangqi LIU, San Diego, CA (US); Mostafa KHOSHNEVISAN, San Diego, CA (US); Huilin XU, Temecula, CA (US); Le LIU, San Jose, CA (US)

(21) Appl. No.: 18/642,383

(22) Filed: Apr. 22, 2024

(51) Int. Cl. H04W 72/0446; H04W 72/0453; H04W 72/12; H04W 72/231

(52) U.S. Cl. CPC H04W 72/0446; H04W 72/0453; H04W 72/12; H04W 72/231

(57) ABSTRACT

Methods, systems, and devices for wireless communications are described. A UE may receive first control signaling that indicates a set of communication parameters for communications by the UE via a set of time and frequency resources. The set of communication parameters may support communications according to a first throughput, or at least a first processing timeline, or both. The UE may receive second control signaling that indicates a threshold throughput that is less than the first throughput, a threshold processing timeline that is longer than the first processing timeline, or both for communications by the UE. The UE may communicate via the set of time and frequency resources in accordance with the set of communication parameters and the threshold throughput or the threshold processing timeline, or both.

### FIELD OF TECHNOLOGY

The following relates to wireless communications, including communication configurations for reduced power consumption.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support communication configurations for reduced power consumption. For example, the described techniques provide for receiving, at a user equipment (UE), first control signaling that indicates a set of communication parameters for communications by the UE via a set of time and frequency resources. The set of communication parameters may support communications according to a first throughput, or at least a first processing timeline, or both. The UE may receive second control signaling that indicates a threshold throughput that is less than the first throughput, a threshold processing timeline that is longer than the first processing timeline, or both for communications by the UE. The UE may communicate via the set of time and frequency resources in accordance with the set of communication parameters and the threshold throughput or the threshold processing timeline, or both.

A method by a UE is described. The method may include receiving first control signaling that indicates a set of communication parameters for communications by the UE via a set of time and frequency resources, where the set of communication parameters support communications according to a first throughput, or at least a first processing timeline, or both, receiving second control signaling that indicates a threshold throughput that is less than the first throughput, a threshold processing timeline that is longer than the first processing timeline, or both for communications by the UE, and communicating via the set of time and frequency resources in accordance with the set of communication parameters and the threshold throughput or the threshold processing timeline, or both.

A UE is described. The UE may include one or more memories storing processor executable code, and one or more processors coupled with the one or more memories. The one or more processors may individually or collectively be operable to execute the code to cause the UE to receive first control signaling that indicates a set of communication parameters for communications by the UE via a set of time and frequency resources, where the set of communication parameters support communications according to a first throughput, or at least a first processing timeline, or both, receive second control signaling that indicates a threshold throughput that is less than the first throughput, a threshold processing timeline that is longer than the first processing timeline, or both for communications by the UE, and communicate via the set of time and frequency resources in accordance with the set of communication parameters and the threshold throughput or the threshold processing timeline, or both.

Another UE is described. The UE may include means for receiving first control signaling that indicates a set of communication parameters for communications by the UE via a set of time and frequency resources, where the set of communication parameters support communications according to a first throughput, or at least a first processing timeline, or both, means for receiving second control signaling that indicates a threshold throughput that is less than the first throughput, a threshold processing timeline that is longer than the first processing timeline, or both for communications by the UE, and means for communicating via the set of time and frequency resources in accordance with the set of communication parameters and the threshold throughput or the threshold processing timeline, or both.

A non-transitory computer-readable medium storing code is described. The code may include instructions executable by one or more processors to receive first control signaling that indicates a set of communication parameters for communications by the UE via a set of time and frequency resources, where the set of communication parameters support communications according to a first throughput, or at least a first processing timeline, or both, receive second control signaling that indicates a threshold throughput that is less than the first throughput, a threshold processing timeline that is longer than the first processing timeline, or both for communications by the UE, and communicate via the set of time and frequency resources in accordance with the set of communication parameters and the threshold throughput or the threshold processing timeline, or both.

In some examples of the method, UEs, and non-transitory computer-readable medium described herein, receiving the second control signaling may include operations, features, means, or instructions for receiving, via the second control signaling, a scaling factor associated with the threshold throughput, the threshold processing timeline, or both, where the threshold throughput, the threshold processing timeline, or both may be based on the scaling factor applied to the first throughput, or the first processing timeline, or both.

In some examples of the method, UEs, and non-transitory computer-readable medium described herein, receiving the second control signaling may include operations, features, means, or instructions for receiving, via the second control signaling, a threshold transport block (TB) size associated with a threshold time period, where the threshold throughput may be based on the threshold TB size and the threshold time period.

In some examples of the method, UEs, and non-transitory computer-readable medium described herein, receiving the second control signaling may include operations, features, means, or instructions for receiving, via the second control signaling, an indication of a first limited-buffer rate-matching (LBRM) value from among a set of multiple LBRM values associated with the set of communication parameters, where the threshold throughput, the threshold processing timeline, or both may be based on the first LBRM value.

In some examples of the method, UEs, and non-transitory computer-readable medium described herein, receiving the second control signaling may include operations, features, means, or instructions for receiving, via the second control signaling, an indication of a threshold quantity of consecutive transmission time intervals (TTIs) for communications by the UE, where the threshold throughput, the threshold processing timeline, or both may be based on the threshold quantity of consecutive slots.

Some examples of the method, UEs, and non-transitory computer-readable medium described herein may further include operations, features, means, or instructions for generating a feedback message according to a codebook, where a size of the codebook may be based on the threshold quantity of consecutive TTIs.

Some examples of the method, UEs, and non-transitory computer-readable medium described herein may further include operations, features, means, or instructions for transmitting a UE capability message that indicates a second throughput, a second processing timeline, or both that may be supported by the UE, where the threshold throughput may be less than or equal to the second throughput, the threshold processing timeline may be greater than or equal to the second processing timeline, or both based on the UE capability message.

Some examples of the method, UEs, and non-transitory computer-readable medium described herein may further include operations, features, means, or instructions for receiving a control message including the first control signaling that indicates the set of communication parameters and the second control signaling that indicates the threshold throughput, the threshold processing timeline, or both for the communications by the UE, where the control message includes a downlink control information (DCI) message, a medium access control-control element (MAC-CE), a bandwidth part (BWP) configuration message, a configuration profile message, a radio resource control (RRC) message, or any combination thereof.

In some examples of the method, UEs, and non-transitory computer-readable medium described herein, receiving the second control signaling may include operations, features, means, or instructions for receiving, via the second control signaling, a DCI message, a MAC-CE, or a RRC message that indicates the threshold throughput, the threshold processing timeline, or both for the communications by the UE.

In some examples of the method, UEs, and non-transitory computer-readable medium described herein, receiving the second control signaling may include operations, features, means, or instructions for receiving, via the second control signaling, a search space set group (SSSG) configuration or a slot format indication message that indicates the threshold throughput, the threshold processing timeline, or both for the communications by the UE.

In some examples of the method, UEs, and non-transitory computer-readable medium described herein, the threshold throughput, the threshold processing timeline, or both apply to a single communication type from among a set of multiple communication types, the set of multiple communication types including multicast communications, broadcast communications, unicast communications, or any combination thereof.

Some examples of the method, UEs, and non-transitory computer-readable medium described herein may further include operations, features, means, or instructions for operating, based on the second control signaling, according to a first power configuration for the UE, where the first power configuration for the UE supports the threshold throughput, the threshold processing timeline, or both, and where the first power configuration for the UE consumes less power than a second power configuration for the UE that supports the first throughput supported by the set of communication parameters, the first processing timeline supported by the set of communication parameters, or both.

In some examples of the method, UEs, and non-transitory computer-readable medium described herein, the set of communication parameters include at least a rank, a bandwidth, a modulation and coding scheme (MCS), or a combination thereof.

A method by a network entity is described. The method may include output first control signaling that indicates a set of communication parameters for communications by a UE via a set of time and frequency resources, where the set of communication parameters support communications according to a first throughput, or at least a first processing timeline, or both, output second control signaling that indicates a threshold throughput that is less than the first throughput, a threshold processing timeline that is longer than the first processing timeline, or both for communications by the UE, and communicating via the set of time and frequency resources in accordance with the set of communication parameters and the threshold throughput or the threshold processing timeline, or both.

A network entity is described. The network entity may include one or more memories storing processor executable code, and one or more processors coupled with the one or more memories. The one or more processors may individually or collectively be operable to execute the code to cause the network entity to output first control signal that indicates a set of communication parameters for communications by a UE via a set of time and frequency resources, where the set of communication parameters support communications according to a first throughput, or at least a first processing timeline, or both, output second control signal that indicates a threshold throughput that is less than the first throughput, a threshold processing timeline that is longer than the first processing timeline, or both for communications by the UE, and communicate via the set of time and frequency resources in accordance with the set of communication parameters and the threshold throughput or the threshold processing timeline, or both.

Another network entity is described. The network entity may include means for output first control signaling that indicates a set of communication parameters for communications by a UE via a set of time and frequency resources, where the set of communication parameters support communications according to a first throughput, or at least a first processing timeline, or both, means for output second control signaling that indicates a threshold throughput that is less than the first throughput, a threshold processing timeline that is longer than the first processing timeline, or both for communications by the UE, and means for communicating via the set of time and frequency resources in accordance with the set of communication parameters and the threshold throughput or the threshold processing timeline, or both.

A non-transitory computer-readable medium storing code is described. The code may include instructions executable by one or more processors to output first control signal that indicates a set of communication parameters for communications by a UE via a set of time and frequency resources, where the set of communication parameters support communications according to a first throughput, or at least a first processing timeline, or both, output second control signal that indicates a threshold throughput that is less than the first throughput, a threshold processing timeline that is longer than the first processing timeline, or both for communications by the UE, and communicate via the set of time and frequency resources in accordance with the set of communication parameters and the threshold throughput or the threshold processing timeline, or both.

In some examples of the method, network entities, and non-transitory computer-readable medium described herein, outputting the second control signaling may include operations, features, means, or instructions for output, via the second control signaling, a scaling factor associated with the threshold throughput, the threshold processing timeline, or both, where the threshold throughput, the threshold processing timeline, or both may be based on the scaling factor applied to the first throughput, or the first processing timeline, or both.

In some examples of the method, network entities, and non-transitory computer-readable medium described herein, outputting the second control signaling may include operations, features, means, or instructions for output, via the second control signaling, a threshold TB size associated with a threshold time period, where the threshold throughput may be based on the threshold TB size and the threshold time period.

In some examples of the method, network entities, and non-transitory computer-readable medium described herein, outputting the second control signaling may include operations, features, means, or instructions for output, via the second control signaling, an indication of a first LBRM value from among a set of multiple LBRM values associated with the set of communication parameters, where the threshold throughput, the threshold processing timeline, or both may be based on the first LBRM value.

In some examples of the method, network entities, and non-transitory computer-readable medium described herein, outputting the second control signaling may include operations, features, means, or instructions for output, via the second control signaling, an indication of a threshold quantity of consecutive TTIs for communications by the UE, where the threshold throughput, the threshold processing timeline, or both may be based on the threshold quantity of consecutive slots.

### BRIEF DESCRIPTION OF THE DRAWINGS

FIG. 1 shows an example of a wireless communications system that supports communication configurations for reduced power consumption in accordance with one or more aspects of the present disclosure.

FIG. 2 shows an example of a wireless communications system that supports communication configurations for reduced power consumption in accordance with one or more aspects of the present disclosure.

FIG. 3 shows an example of a communications timeline that supports communication configurations for reduced power consumption in accordance with one or more aspects of the present disclosure.

FIG. 4 shows an example of a process flow that supports communication configurations for reduced power consumption in accordance with one or more aspects of the present disclosure.

FIGS. 5 and 6 show block diagrams of devices that support communication configurations for reduced power consumption in accordance with one or more aspects of the present disclosure.

FIG. 7 shows a block diagram of a communications manager that supports communication configurations for reduced power consumption in accordance with one or more aspects of the present disclosure.

FIG. 8 shows a diagram of a system including a device that supports communication configurations for reduced power consumption in accordance with one or more aspects of the present disclosure.

FIGS. 9 and 10 show block diagrams of devices that support communication configurations for reduced power consumption in accordance with one or more aspects of the present disclosure.

FIG. 11 shows a block diagram of a communications manager that supports communication configurations for reduced power consumption in accordance with one or more aspects of the present disclosure.

FIG. 12 shows a diagram of a system including a device that supports communication configurations for reduced power consumption in accordance with one or more aspects of the present disclosure.

FIGS. 13 through 17 show flowcharts illustrating methods that support communication configurations for reduced power consumption in accordance with one or more aspects of the present disclosure.

### DETAILED DESCRIPTION

In some wireless communications systems, a network entity may transmit an indication of one or more communication profiles for communications by a UE. The communication profiles may be associated with different sets of communication parameters and may support different threshold (e.g., maximum) throughputs and threshold (e.g., minimum) processing timelines. A communication profile may represent examples of a configuration profile, a bandwidth part (BWP) configuration, or some other type of configuration and may be referred to as a set of communication parameters in some examples described herein. The communication parameters may include bandwidth, rank, modulation and coding scheme (MCS), or any combination thereof. In some cases, the network entity may determine to switch configuration profiles to, for example, minimize transmission time or reduce network energy consumption, but the network entity may not transmit at a maximum throughput or may not expect feedback according to a minimum processing timeline associated with the configuration profile to which the network entity switches. However, if the UE receives an indication of a new configuration profile, the UE may adjust a power mode of the UE to support the maximum possible throughput and the minimum possible processing timeline for the new configuration profile. Accordingly, if the network entity does not transmit to the UE at the maximum throughput or expect feedback from the UE according to the minimum processing timeline, the UE may unnecessarily enter a high-power mode, which may increase power consumption and processing.

According to techniques described herein, the network entity may transmit, to a UE, an indication of an adjusted threshold (e.g., maximum) throughput or an adjusted threshold (e.g., minimum) processing timeline for a given configuration profile. The UE may thereby support the adjusted communication thresholds for the given configuration profile, which may reduce power consumption by the UE as compared to the original communication thresholds. For example, the network entity may transmit an indication for the UE to switch from a first configuration profile to a second configuration profile that supports a higher throughput, a shorter processing timeline, or both, than the first configuration profile. The network entity may transmit an indication of the adjusted threshold throughput, the adjusted threshold processing timeline, or both. The adjusted threshold throughput may be less than the maximum throughput associated with the communication parameters of the second configuration profile, and the adjusted threshold processing timeline may be longer than the minimum processing timeline associated with the communication parameters of the second configuration profile. The UE may thereby reduce power consumption by, for example, remaining in a low-power mode based on the adjusted threshold throughput or the adjusted threshold processing timeline. For example, the UE may stay in or enter a low-power mode based on determining that the UE can receive and process transmissions in accordance with the adjusted threshold throughput or the adjusted threshold processing timeline, regardless of the second configuration profile.

Aspects of the disclosure are initially described in the context of wireless communications systems. Aspects of the disclosure are further illustrated by and described with reference to apparatus diagrams, system diagrams, and flowcharts that relate to communication configurations for reduced power consumption.

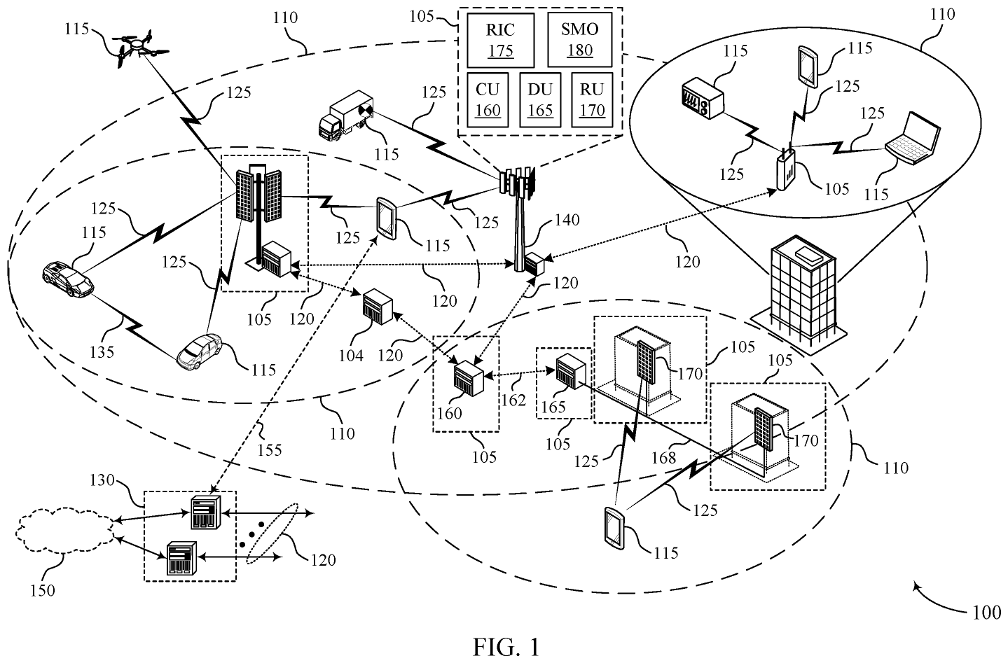

FIG. 1 shows an example of a wireless communications system 100 that supports communication configurations for reduced power consumption in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The network entity 105 may schedule communications with the UE 115 based on a minimum scheduling offset. The minimum scheduling offset may be the minimum gap between a slot containing a physical downlink control channel (PDCCH) and the slot that contains the scheduled physical downlink shared channel (PDSCH) or a physical uplink shared channel (PUSCH). The gap may be denoted KO for PDSCH and K2 for PUSCH. That is, when KO equals zero, the PDCCH may schedule PDSCH in the same slot. When KO equals one, the PDCCH may schedule PDSCH in the next slot. Similarly, when K2 equals zero, the PDCCH may schedule PUSCH in the same slot. When K2 equals one, the PDCCH may schedule PUSCH in the next slot.

The network entity 105 may additionally, or alternatively, utilize a minimum processing time when scheduling resources for feedback from the UE 115 in response to a downlink transmission. The minimum time between the end of a PDSCH and the beginning of the PUCCH that includes feedback for the PDSCH may be referred to as T_{proc,1}, which may be measured in milliseconds, and may be referred to as N₁ when measured in symbols, in some examples. The minimum processing timeline, which may also be referred to as a PDSCH processing timeline or a feedback timeline, may represent a gap between the end of a data reception at the UE 115 (e.g., PDSCH) and the beginning of a feedback opportunity (e.g., PUCCH resources) for transmission of feedback by the UE 115. A UE 115 may support one or more PDSCH processing capabilities, including, for example, a regular PDSCH processing capability and a fast PDSCH processing capability (e.g., an optionally supported fast capability associated).

According to techniques described herein, a network entity 105 may transmit, to a UE 115, an indication of an adjusted threshold (e.g., maximum) throughput or an adjusted threshold (e.g., minimum) processing timeline for a given configuration profile. The UE 115 may thereby support the adjusted communication thresholds for the given configuration profile, which may reduce power consumption by the UE 115 as compared to the original communication thresholds. For example, the network entity 105 may transmit an indication for the UE 115 to switch from a first configuration profile to a second configuration profile that supports a higher throughput, a shorter processing timeline, or both than the first configuration profile. The network entity 105 may transmit an indication of the adjusted threshold throughput, the adjusted threshold processing timeline, or both. The adjusted threshold throughput may be less than the maximum throughput associated with the communication parameters of the second configuration profile, and the adjusted threshold processing timeline may be longer than the minimum processing timeline associated with the communication parameters of the second configuration profile. The UE 115 may thereby reduce power consumption by, for example, remaining in a low-power mode based on the adjusted threshold throughput or the adjusted threshold processing timeline. For example, the UE 115 may stay in or enter a low-power mode based on determining that the UE 115 can receive and process transmissions in accordance with the adjusted threshold throughput or the adjusted threshold processing timeline, regardless of the second configuration profile.

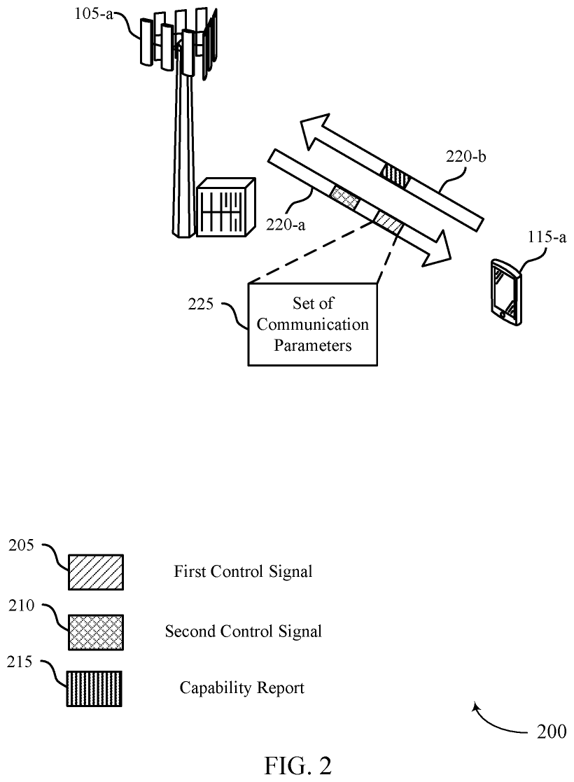

FIG. 2 shows an example of a wireless communications system 200 that supports communication configurations for reduced power consumption in accordance with one or more aspects of the present disclosure. In some examples, wireless communications system 200 may implement aspects of wireless communications system 100. For example, a UE 115-a may represent an example of a UE, such as the UEs 115 described with reference to FIG. 1. The network entity 105-a may represent an example of a network entity, such as the network entity 105 described with reference to FIG. 1. The network entity 105-a and the UE 115-a may communicate via one or more communication links 220, including a downlink communication link 220-a and an uplink communication link 220-b. As described herein, the network entity 105-a may dynamically indicate one or more adjusted threshold parameters for the UE 115-a to use for communications, which may provide for the UE 115-a to reduce power consumption while maintaining reliable communications.

In some wireless communications systems, the network entity 105-a may configure one or more sets of communication parameters (e.g., BWP configurations or configuration profiles) relating to downlink reception and uplink transmission by a UE 115-a. The sets of communication parameters may be referred to as or may represent examples of BWP configurations, configuration profiles, or any combination thereof. For example, the network entity 105-a may transmit a RRC configuration message or some other type of configuration message that indicates the one or more sets of communication parameters. The configuration parameters may include a maximum bandwidth for scheduling, a maximum rank, a maximum modulation order (e.g., by configuring which MCS table is used), other parameters for communications between the UE 115-a and the network entity 105-a, or any combination thereof. In some cases, a BWP configuration framework may allow the network entity 105-a to switch configuration parameters relatively easily (e.g., without RRC reconfiguration or other configurations).

For example, by indicating multiple candidate sets of communication parameters to the UE 115-a via some initial configuration message, the network entity 105-a may dynamically activate and deactivate various sets of communication parameters during communication with the UE 115-a. The network entity 105-a may switch communication parameters during communications, and may indicate the switch to the UE 115-a via a first control signal 205 (e.g., a downlink control information (DCI) message, a MAC-control element (MAC-CE) or some other type of signaling). The network entity 105-a may switch the set of communication parameters 225 based on downlink traffic conditions. For example, the network entity 105-a may switch from a set of communication parameters associated with a narrowband to a set of communication parameters 225 associated with a wideband based on downlink traffic to the UE 115-a (e.g., if the downlink traffic may be improved by increasing a bandwidth). The network entity 105-a may transmit the first control signal 205 and indicate for the UE 115-a to switch from a first set of communication parameters associated with a narrow bandwidth, a low rank, or a low modulation order to a second set of communication parameters 225 associated with a wide bandwidth, a high rank, or a high modulation order. In some cases, the network entity 105-a may switch to the second set of communication parameters 225 in order to increase throughput to the UE 115-a, among other examples.

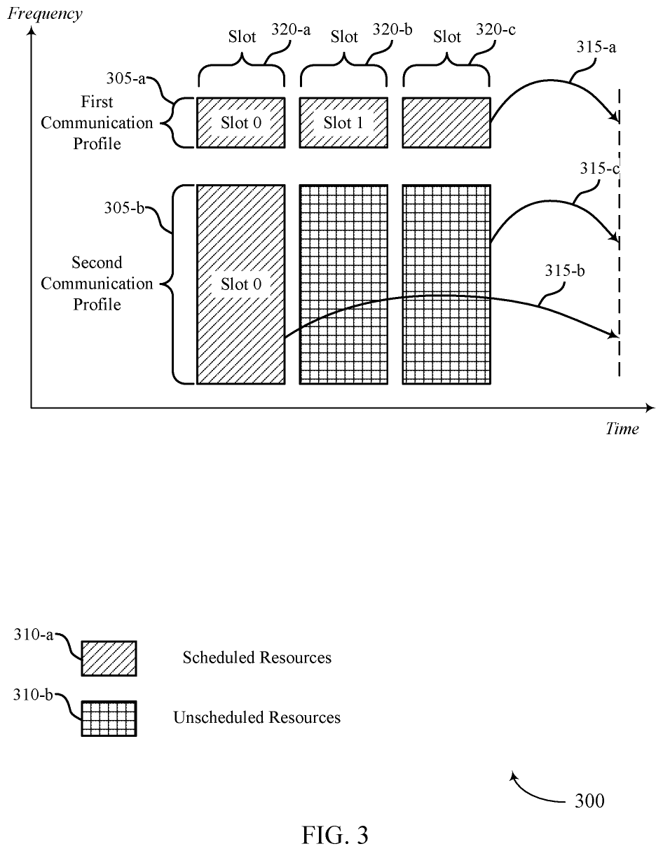

In some cases, the network entity 105-a may benefit from communications in a relatively wide bandwidth, associated with a relatively high rank, or using a relatively high MCS. Such communication parameters may represent examples of relatively high throughput sets of communication parameters associated with a threshold (e.g., maximum) throughput, a threshold (e.g., minimum) processing timeline, or both. The threshold processing timeline may correspond to a minimum amount of time for a UE 115 to process and respond to communications, as described in further detail elsewhere herein, including with reference to FIG. 3. The higher throughput and reduced processing timeline may reduce transmission time, reduce network energy consumption, provide for the network entity 105-a to serve more UEs 115, or any combination thereof as compared with a lower throughput and higher processing timeline. For example, by switching to the set of communication parameters 225 associated with relatively high throughput (e.g., higher throughput than a previously used set of communication parameters), the network entity 105-a may complete a transmission to the UE 115-a in a shorter time period than if the network entity 105-a uses the previously used set of communication parameters for the transmission (e.g., a completion time of one millisecond, while the transmission may be complete in five milliseconds using a low throughput set of communication parameters, or some other duration). Other sets of communication parameters 225 may be associated with a relatively narrow bandwidth, a relatively low rank, a relatively low MCS, or any combination thereof, and may be associated with lower throughput, greater processing timelines, or both. The network entity 105-a may thereby dynamically signal for the UE 115-a to switch sets of communication parameters 225 to adjust a throughput, processing timeline, or both based on conditions associated with the communications.

The UE 115-a may receive the first control signal 205 and may operate according to a greatest throughput, a smallest scheduling offset, or a shortest feedback timeline that are permitted by the set of communication parameters 225 indicated via the control signal 205. That is, the UE 115-a may assume and conform to the thresholds for communications using the indicated communication parameters. The UE 115-a may thereby operate in a mode that supports up to the maximum throughput and supports processing within the minimum processing timeline. The UE 115-a may enter a higher power mode to be ready to receive or transmit at the peak rate (e.g., according to the maximum throughput or minimum processing timeline). For example, if the UE 115-a is scheduled for transmission or reception of one bit of data per second, but the set of configuration parameters 225 associated with a maximum throughput of one gigabit per second, the UE 115-a may enter a higher power mode in order to receive at the peak data rate (e.g., one gigabit per second, or some other peak data rate). The higher power mode at the UE 115-a may involve higher clock frequency and a higher supply voltage to support the higher clock frequency and faster processing operations. The higher power mode may lead to a super-linear increase in power consumption. If the network entity 105-a does not transmit to the UE 115-a at the maximum throughput or schedule feedback from the UE 115-a according to the minimum processing timeline, the UE 115-a may unnecessarily enter the higher power mode, which may increase power consumption and processing. It may be beneficial for the network entity 105-a to switch the set of communication parameters to a set of communication parameters 225 that is associated with a wider bandwidth, higher rank, multiple activated cells, or higher MCS operation to improve or otherwise support reliable communications with one or more UEs 115 while still communicating according to a reduced throughput, a higher processing timeline, or both.

According to techniques described herein, the network entity 105-a may transmit to a UE 115-a, a second control signal 210 (e.g., or some other message) indicating an adjusted threshold throughput (e.g., an adjusted maximum throughput) or an adjusted threshold processing timeline (e.g., an adjusted minimum processing timeline) for a given set of communication parameters 225 (e.g., configuration profile). The UE 115-a may thereby support the adjusted communication thresholds for the given set of communication parameters 225, which may reduce power consumption by the UE 115-a as compared to the communication thresholds originally configured for the given set of communication parameters 225. For example, the network entity 105-a may transmit the first control signal 205 indicating for the UE 115-a to switch from a first set of communication parameters to a second set of communication parameters 225 that supports a higher throughput, a shorter processing timeline, or both. The network entity 105-a may transmit the second control signal 210 indicating a threshold throughput, a threshold processing timeline, or both for the UE 115-a to use (e.g., assume, operate according to) when communicating using the indicated second set of communication parameters 225. The threshold throughput and the threshold processing timeline indicated via the second control signal 210 may be referred to as adjusted thresholds, in some examples. For example, the threshold throughput may be less than the maximum throughput associated with the second set communication parameters 225, and the threshold processing timeline may be longer than the minimum processing timeline associated with the second set of communication parameters 225. For example, multiple candidate sets of communication parameters, including the first and second sets, are configured for communications by the UE 115-a and the network entity 105-a (e.g., via control signaling, such as an RRC configuration, defined in a standard, or via some other configuration), and the configuration may additionally indicate a respective maximum throughput and minimum processing timeline for each set. The network entity 105-a may indicate, via the second control signal 210, some other threshold throughput that is less than the maximum throughput originally configured for the second set of communication parameters 225, some other threshold processing timeline that is greater than the minimum processing timeline originally configured for the second set of communication parameters 225, or both. The UE 115-a may thereby reduce power consumption by, for example, remaining in a lower power mode or otherwise maintaining a current mode and corresponding power consumption based on the adjusted threshold throughput or the adjusted threshold processing timeline. For example, the UE 115-a may stay in or enter a lower power mode based on determining that the UE 115-a can receive and process communications in accordance with the threshold throughput or the threshold processing timeline, regardless of the maximum throughput and minimum processing timeline associated with the second set of communication parameters 225.

For example, the network entity 105-a may indicate at least one of a threshold throughput (e.g., a maximum schedulable sustained throughput) lower than the maximum throughput (e.g., peak throughput possible given the current configuration) or a threshold processing timeline (e.g., minimum data processing (or feedback) timeline) larger than the minimum processing timeline (e.g., minimum possible value reported by the UE 115-a). The network entity 105-a may provide the indication via the second control signal 210 and the indication may be associated with a set of communication parameters 225. In some cases, the network entity 105-a may transmit the second control signal 210 as part of an RRC configuration or reconfiguration. In some cases, the network entity 105-a may transmit the second control signal 210 based on a change in the bandwidth. In some cases, the network entity 105-a may transmit the second control signal 210 based on a change in the maximum quantity of MIMO layers. In some cases, the network entity 105-a may transmit the second control signal 210 based on a change in the maximum modulation order, code-rate, MCS, or MCS table. In some cases, the network entity 105-a may transmit the second control signal 210 based on a switch in a BWP or configuration profile. In some cases, the network entity 105-a may transmit the second control signal 210 based on cells being activated or cells being deactivated. In some cases, the network entity 105-a may transmit the second control signal 210 based on a threshold throughput associated with communications with the UE 115-a being lower than the maximum throughput.

The network entity 105-a may indicate the threshold throughput or threshold processing timeline via the second control signal 210. In some cases, the indication may include a scaling factor z. The UE 115-a may receive the scaling factor and may use the scaling factor to determine (e.g., calculate) the adjusted threshold throughput and/or threshold processing timeline the UE 115-a is to use. For example, the maximum throughput associated with the indicated set of communication parameters 225 may be multiplied or divided by the scaling factor z, The minimum processing timeline associated with the indicated set of communication parameters 225 may be divided or multiplied by the scaling factor z (e.g., a scaling factor of one half may be multiplied by a maximum throughput of one gigabit per second to generate a threshold throughput of 500 megabits per second), or both to obtain the adjusted thresholds. The scaling factor associated with the threshold throughput and the scaling factor associated with the threshold processing timeline may be the same or different. In some cases, if the UE 115-a receives a scaling factor of two, the UE 115-a may assume that the network entity 105-a may transmit to the UE 115-a at half the maximum throughput and the UE 115-a may process and prepare to transmit feedback in accordance with twice the minimum processing timeline.

In some cases, the indication of the threshold throughput or the threshold processing timeline may include an explicit limit on the throughput or an explicit limit on the processing timeline. For example, the network entity 105-a may indicate, via the second signal 210, one or more values (e.g., bits, fields) that indicate a threshold throughput, a threshold processing timeline, or both. In some cases, the indication of the threshold throughput or threshold processing timeline may include the maximum transport block (TB) size that may be scheduled in a time window. The maximum TB size may be in units of time, symbols, slots, or some other unit of time. For example, the network entity 105-a may indicate, via the second signal 210, one or more values (e.g., bits, fields) that represent a maximum quantity of time units to be included in each TB of a given transmission to the UE 115-a within a given time window. The maximum TB size may correspond to a maximum throughput, in some examples.

In some cases, the indication may include a limit on a limited-buffer rate-matching (LBRM). The network entity 105-a may schedule a message according to a maximum TB size or a threshold throughput, and retransmissions may provide incremental redundancy. The LBRM may set a threshold code rate (e.g., ⅓ or some other threshold). For code rates lower than the threshold code rate, the lower code rate may be achieved via additional redundancy. For example, the additionally redundancy may reduce the code rate from a first code rate to a second code rate, where the second code rate may be associated with a smaller decoding time (e.g., the first code rate may be ⅓ and the second code rate may be ⅔). One or more values for the LBRM may be provided based on the bandwidth (e.g., as part of an initial configuration for the set of communication parameters) and the network entity 105-a may indicate, which LBRM parameters of the multiple indicated LBRM parameters may be applied for the set of communication parameters 225.

In some cases, the indication of the threshold throughput or the threshold processing timeline may include a maximum quantity of consecutive slots on which the UE 115-a may be scheduled (e.g., the network entity 105-a may indicate that the UE 115-a may be schedule for at maximum one consecutive slot, or some other quantity of consecutive slots). In some cases, the indication may include a maximum quantity of consecutive durations on which the UE 115-a may be scheduled, where the durations may be slots, symbols, or some other duration. The indication of the maximum quantity of consecutive slots on which the UE 115-a may be scheduled may represent a threshold throughput the UE 115-a can expect. In some cases, the indication of the threshold throughput or threshold processing timeline may include a maximum quantity of slots in a given duration on which the UE may be scheduled (e.g., the network entity 105-a may indicate that the UE 115-a may be scheduled for at maximum one slot in a four slot time period). In some cases, the indication of the threshold throughput or threshold processing timeline may include a maximum portion of a given duration (e.g., a slot or some other duration) on which the UE 115-a may be scheduled. In some cases, the throughput may be calculated in a sliding window. For example, a scheduled slot may be accounted for in multiple different adjacent windows.

The network entity 105-a may transmit the first control signal 205 and the second control signal 210 via separate messages or a same message and in any order in time. In some cases, the indication of the threshold throughput or threshold processing timeline may be conveyed via one or more RRC parameters. For example, the network entity 105-a may transmit an RRC message that includes at least the second control signal 210. The RRC message may indicate multiple sets of communication parameters that are candidates for use during communications with the network entity 105-a, and the RRC message may further indicate an adjusted threshold throughput or processing timeline for one or more of the sets of communication parameters. In such cases, the network entity 105-a may transmit another message (e.g., a DCI or MAC-CE) including the first control signal 205 to dynamically switch communication parameters, and the UE 115-a may know which adjusted threshold throughput and/or processing timeline to use based on the RRC configuration.

In some cases, the indication of the adjusted threshold throughput, the adjusted threshold processing timeline, or both may be part of a BWP configuration or a configuration profile. That is, the indication may be conveyed as one of the communication parameters in a set of communication parameters 225. In such cases, the first control signal 205 and the second control signal 210 may be transmitted via a same message. For example, each set of communication parameters that are supported by the UE 115-a may be associated with a respective adjusted threshold throughput or processing timeline, or both. In such cases, if a first set of communication parameters includes a corresponding adjusted threshold throughput, threshold processing timeline, or both, any change or switch to the first set of communication parameters may be accompanied by imposing or communicating according to the adjusted limitations. In some cases, the indication may be a part of the first control signal 205 (e.g., a message, such as a DCI message or a MAC-CE) that indicates a change to a new set of communication parameters (e.g., a new wider bandwidth, higher rank, higher MCS, higher BWP, or configuration profile operation). In such examples, the second control signal 210 may be included in the same message. The single message may indicate the switch in sets of communication parameters as well as the indication of the adjusted threshold throughput, the adjusted threshold processing timeline, or both. The limitation (e.g., the adjusted maximum throughput or the adjusted minimum processing timeline, or both) may apply or may not apply depending on the signaling from the network entity 105-a. For example, the second control signal 210 may indicate whether the UE 115-a is to apply the indicated adjusted limitations or not.

In some cases, the indication may be a part of the search space set group (SSSG) (e.g., SSSG included in RRC). The SSSG may indicate a search space configuration. The SSSG may be changed as part of the set of communication parameters or independently. For example, an SSSG may be switched from a first SSSG configuration associated with monitoring for control information at the UE 115-a every slot to a second SSSG configuration associated with monitoring for control information at the UE 115-a every four slots, or some other periodicity. In some examples, an SSSG may be switched from a first SSSG configuration associated with monitoring twenty candidates per slot to a second SSSG configuration associated with monitoring ten candidates per slot, or some other monitoring frequency. In some cases, the adjusted threshold throughput or the adjusted threshold processing timeline may be applied without changing other operation parameters (e.g., the set of communication parameters communication parameters). In other words, the set of communication parameters may remain constant even if the SSSG configuration changes. In some cases, the SSSG configuration may change based on a switch in the set of communication parameters.

In some cases, the indication may be conveyed via the second control signal 210, which may be separate from the first control signal 205 that indicates the change to a different set of communication parameters. For example, the network entity 105-a may transmit, via the first control signal 205, an indication for the UE 115-a to switch to a second set of communication parameters 225. The network entity 105-a may separately transmit the second signal 210 to indicate the adjusted threshold throughput, the adjusted threshold processing timeline, or both for the UE 115-a to use when communicating according to the second set of communication parameters 225. In such cases, the network entity 105-a may transmit the second signal 210 with or without changing the set of communication parameters. As such, the adjusted threshold throughput and threshold processing timeline may be indicated and applied without changing other operation parameters, in some cases. In some cases, the indication of the adjusted threshold throughput, the adjusted threshold processing timeline, or both may be conveyed via a slot-format indication message (e.g., SFI). That is, the network entity 105-a may transmit, via the second control signal 210, an indication of a new slot type along with the indication of the adjusted threshold throughput, the adjusted threshold processing timeline, or both for the UE 115-a to use with the new slot type.

In some cases, the UE 115-a may transmit a capability report 215 to the network entity 105-a. The capability report 215 may indicate a threshold processing timeline value or a threshold throughput value that the UE 115-a can support while maintaining relatively energy efficient reception. The threshold processing timeline value or the threshold throughput value may be reported as a per bandwidth value (e.g., the UE 115-a may transmit a first timeline value for 100 MHz scheduled bandwidth, and a second timeline value for 200 MHz scheduled bandwidth, and so on). Additionally, or alternatively, the UE 115-a may indicate a single supported value for the threshold throughput, the threshold processing timeline, or both, which may be applied across bandwidths. The reporting may be part of the UE capability or a UE assistant framework. In some cases, the UE 115-a may indicate that, given a current battery state of the UE 115-a, the UE 115-a cannot sustain the current maximum throughput and the UE 115-a may support a reduced throughput for a current communication configuration. In some cases, the threshold throughput, threshold processing timeline, or both may be based on the capability report 215. For example, the network entity 105-a may transmit the second control signal 210 to indicate the threshold throughput, the threshold processing timeline, or both based on the capability report 215 from the UE 115-a.

In some cases, the threshold throughput, the threshold processing timeline, or both may be applied simultaneously for unicast, multicast, and broadcast transmission. For example, a single set of parameters may be provided and may apply to communications of all cast types. In some cases, the threshold throughput, the threshold processing timeline, or both may be applied independently for unicast, multicast, and broadcast transmission (e.g., separate sets of parameters may be provided based on the cast type). For example, the network entity 105-a may indicate a first adjusted threshold throughput, a first adjusted threshold processing timeline, or both for unicast communications with the UE 115-a and a second adjusted threshold throughput, a second adjusted threshold processing timeline, or both for multicast communications with the UE 115-a and one or more other UEs 115.

The network entity 105-a may thereby switch sets of communication parameters to support various different communication scenarios, and the network entity 105-a may additionally indicate an adjustment to a threshold throughput, a threshold processing timeline, or both for a UE 115-a to use after switching to the new set of communication parameters. By indicating the adjusted threshold parameters, the network entity 105-a may support improved communication reliability with one or more different UEs 115 by, for example, adjusting a bandwidth, an MCS, a rank, among other parameters, while maintaining reduced power consumption by the one or more UEs 115, among other benefits.

FIG. 3 shows an example of a communications timeline 300 that supports communication configurations for reduced power consumption in accordance with one or more aspects of the present disclosure. In some examples, communication timeline 300 may implement aspects of, or be implemented by aspects of, the wireless communications system 100 and the wireless communications system 200. For example, a UE 115 and a network entity 105, which may be examples of corresponding devices described with reference to FIGS. 1 and 2, may communicate with each other according to the communication timeline 300.

In some cases, the UE 115 may communicate in accordance with a first communication profile 305-a (e.g., a first set of communication parameters, which also may be referred to as a first BWP configuration) associated with a narrow bandwidth (e.g., a narrowband operation mode (NB)). The maximum throughput may be limited by the maximum available bandwidth in the first communication profile 305-a. In other words, the sustained throughput may be limited. The first communication profile 305-a may additionally be associated with a first minimum processing timeline 315-a, which may correspond to a shortest time period between an end of a message received at the UE 115 and a beginning of a scheduled feedback opportunity. The UE 115 may process the received message and generate feedback within the minimum processing timeline 315-a. Accordingly, the amount of data to decode within the minimum processing timeline 315-a (e.g., feedback timeline) may be relatively low as compared with longer processing timelines, which may be supported by the relatively limited bandwidth available for scheduling in the slot 320-c within the first communication profile 305-a. In other words, instantaneous throughput may be limited.

In some cases, the UE 115 may communicate in accordance with a second communication profile 305-b (e.g., a second set of communication parameters, which also may be referred to as a second BWP configuration) associated with a relatively wide bandwidth (e.g., wideband operation mode (WB)). The maximum throughput supported by the second communication profile 305-b may be higher than the maximum throughput associated with the first communication profile 305-a because the second communication profile 305-b may include a wider bandwidth. The network entity 105 may transmit more data within a given time period using the second communication profile 305-b than the first communication profile 305-a based on the wider bandwidth. In the example of FIG. 3, the scheduled resources 310-a may span across each of slots 320-a, 320-b, and 320-c using the first communication profile 305-a. That is, the network entity 105 may transmit data via the maximum bandwidth of the first communication profile 305-a in each slot 320. The scheduled resources 310-a may span a single slot 320-a using the second communication profile 305-b, and the slots 320-b and 320-c may include unscheduled resources 310-b. That is, the network entity 105 may transmit the same amount of data via the maximum bandwidth of the first communication profile 305-a in a single slot 320-a, which illustrates the increased data rate and data throughput supported by the second communication profile.

While communicating according to the second communication profile 305-b, the network entity 105 may schedule communications in any of the slots 320-a, 320-b, and 320-c, and the minimum processing timeline 315-c supported by the second communication profile 305-b may be the same as in the minimum processing timeline 315-a supported by the first communication profile 305-a. That is, a shortest possible time period over which the UE 115 may process received data and transmit feedback while communicating according to the second communication profile 305-b may correspond to the minimum processing timeline 315-c and may be the same as the minimum processing timeline 315-a.

If the UE 115 receives data in the slot 320-c, the UE 115 may be scheduled to transmit feedback for the data by the same feedback deadline (e.g., illustrated by the dashed line in FIG. 3). The processing timeline 315-b illustrated in FIG. 3 may illustrate a timeline for the UE 115 to prepare feedback when the UE 115 receives data in the slot 320-a and is not scheduled in the slots 320-b and 320-c, and may be greater than the minimum processing timeline 315-c for the second communication profile 305-b. Additionally, or alternatively, in some cases, the minimum processing timeline 315-c for the second communication profile 305-b may be longer than the minimum processing timeline 315-a for the first communication profile 305-a to provide more time for the UE 115 to process the extra bandwidth. For example, although not illustrated in FIG. 3, the feedback deadline for the second communication profile 305-b may be later in time than the feedback deadline for the first communication profile 305-a, which may thereby increase the minimum processing timeline 315-c.

In some examples, the network entity 105 may switch from the first communication profile 305-a to the second communication profile 305-b for one or more reasons. For example, the second communication profile 305-b may support communication with more devices, may support an improved connection, or the like. However, the network entity 105 may not have a reason to increase throughput, in some cases. For example, the network entity 105 may have the same amount of data to transmit in a same time period, but the network entity 105 may benefit from the increased bandwidth configuration, among other examples. In such cases, techniques for dynamically adjusting a threshold (e.g., maximum) throughput, a threshold (e.g., minimum) processing timeline 315, or both for a given communication profile 305 may be beneficial, as the adjustments may provide for reduced power consumption by the UE 115 while operating according to a communication profile 305 that may otherwise be associated with higher throughput or shorter processing timelines.

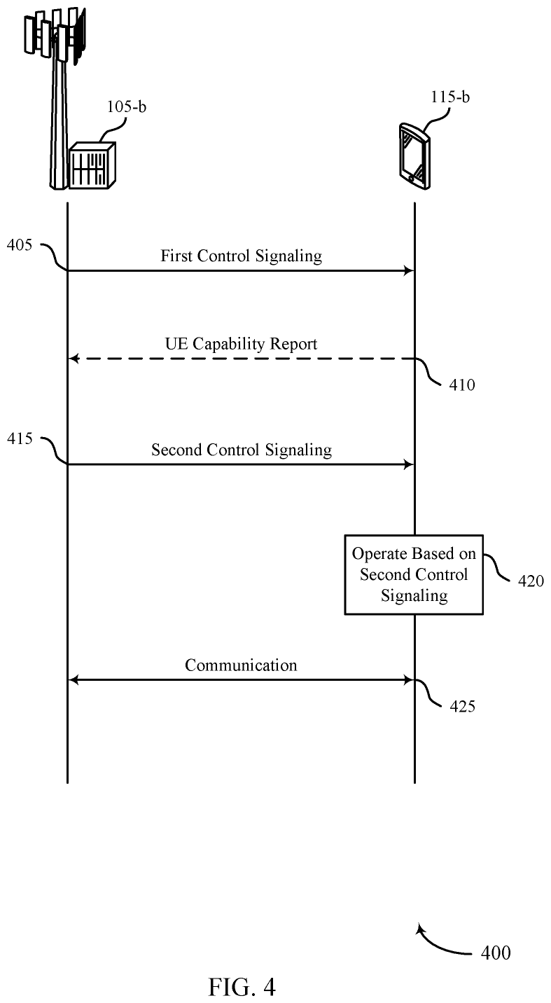

FIG. 4 shows an example of a process flow 400 that supports communication configurations for reduced power consumption in accordance with one or more aspects of the present disclosure. In some examples, process flow 400 may implement aspects of, or be implemented by aspects of, the wireless communications system 100, the wireless communications system 200, or the communications timeline 300. For example, the process flow 400 may include a UE 115-b and a network entity 105-b which may be examples of corresponding devices described with reference to FIGS. 1-3.

In the following description of the process flow 400, the operations between the network entity 105-b and the UE 115-b may be performed in different orders or at different times than the example shown. Some operations may also be omitted from the process flow 400, and other operations may be added to the process flow 400. In this example, the network entity 105-b and the UE 115-b may support dynamic adjustments of communication parameters to reduce power consumption, among other examples.

At 405, the network entity 105-b may output, to the UE 115-b, first control signaling that indicates a set of communication parameters for communications by the UE 115-b via a set of time and frequency resources. The set of communication parameters may support communications according to a first throughput, or at least a first processing timeline, or both. In some examples, the set of communication parameters may represent the second communication profile 305-b as described with reference to FIG. 3, or some other set of communication parameters associated with or including a bandwidth, an MCS, a rank, and the like.

At 410, in some examples, the UE 115-b may transmit a UE capability message that indicates a second throughput, a second processing timeline, or both that are supported by the UE 115-b. For example, the UE 115-b may indicate that the UE 115-b supports processing of data reception in no less than the second processing timeline or that the UE 115-b supports a throughput that is no greater than the second throughput.

At 415, the network entity 105-b may output, to the UE 115-b, second control signaling that indicates a threshold throughput that is less than the first throughput, a threshold processing timeline that is longer than the first processing timeline, or both for communications by the UE 115-b. That is, the network entity 105-b may adjust the throughput, the processing timeline, or both from a maximum throughput or a minimum processing timeline that is supported by the identified set of communication parameters. The threshold throughput may be less than or equal to the second throughput indicated via the UE capability message, and the threshold processing timeline may be greater than or equal to the second processing timeline indicated via the UE capability message, or both based on the UE capability message. That is, the threshold throughput or threshold processing timeline may be based on the UE capability message.

The network entity 105-b may indicate the threshold throughput, threshold processing timeline, or both via one or types of signaling. In some cases, the network entity 105-b may output, to the UE 115-b via the second control signaling, a scaling factor associated with the threshold throughput, the threshold processing timeline, or both. The threshold throughput, the threshold processing timeline, or both may be based on the scaling factor applied to the first throughput, or the first processing timeline, or both, as described in greater detail with reference to FIG. 2. In some cases, the network entity 105-b may output, via the second control signaling, a threshold TB size associated with a threshold time period. The threshold throughput may be based on the threshold TB size and the threshold time period. In some cases, the network entity 105-b may output, via the second control signaling, an indication of a first LBRM value from among multiple candidate LBRM values associated with the set of communication parameters. The threshold throughput, the threshold processing timeline, or both may be based on the first LBRM value. In some cases, the network entity 105-b may output, via the second control signaling, an indication of a threshold quantity of consecutive TTIs for communications by the UE 115-b. The threshold throughput, the threshold processing timeline, or both may be based on the threshold quantity of consecutive TTIs.

The network entity 105-b may include the second control signaling that indicates the threshold throughput, the threshold processing timeline, or both in one or more different message types. In some cases, the network entity 105-b may output a control message including the first control signaling that indicates the set of communication parameters and the second control signaling that indicates the threshold throughput, the threshold processing timeline, or both for the communications by the UE 115-b. The control message may include a DCI message, a MAC-CE, a BWP configuration message, a configuration profile message, an RRC message, or any combination thereof. In some cases, the network entity 105-b may output, via the second control signaling, a DCI message, a MAC-CE, or a RRC message that indicates the threshold throughput, the threshold processing timeline, or both for the communications by the UE 115-b. In some cases, the network entity 105-b may output, via the second control signaling, an SSSG configuration or a slot format indication message that indicates the threshold throughput, the threshold processing timeline, or both for the communications by the UE 115-b.

In some cases, the threshold throughput, the threshold processing timeline, or both may apply to a single communication type from among multiple communication types, including multicast communications, broadcast communications, unicast communications, or any combination thereof. In some cases, the set of communication parameters may include at least a rank, a bandwidth, a MCS, or a combination thereof.

At 420, the UE 115-b may operate, based on the second control signaling, according to a first power configuration for the UE 115-b. The first power configuration for the UE 115-b may support the threshold throughput, the threshold processing timeline, or both. The first power configuration for the UE 115-b may consume less power than a second power configuration for the UE 115-b that supports the first throughput supported by the set of communication parameters, the first processing timeline supported by the set of communication parameters, or both. That is, the second power configuration for the UE 115-b may be associated with a higher clock frequency and a higher supply voltage to support the higher clock frequency and faster processing operations as described with reference to FIG. 2.

At 425, the UE 115-b and the network entity 105-b may communicate via the set of time and frequency resources in accordance with the set of communication parameters and the threshold throughput or the threshold processing timeline, or both. That is, the network entity 105-b may transmit to the UE 115-b at a throughput less than or equal to the threshold throughput, and the network entity 105-b may expect feedback in accordance with a processing timeline greater than or equal to the threshold processing timeline.

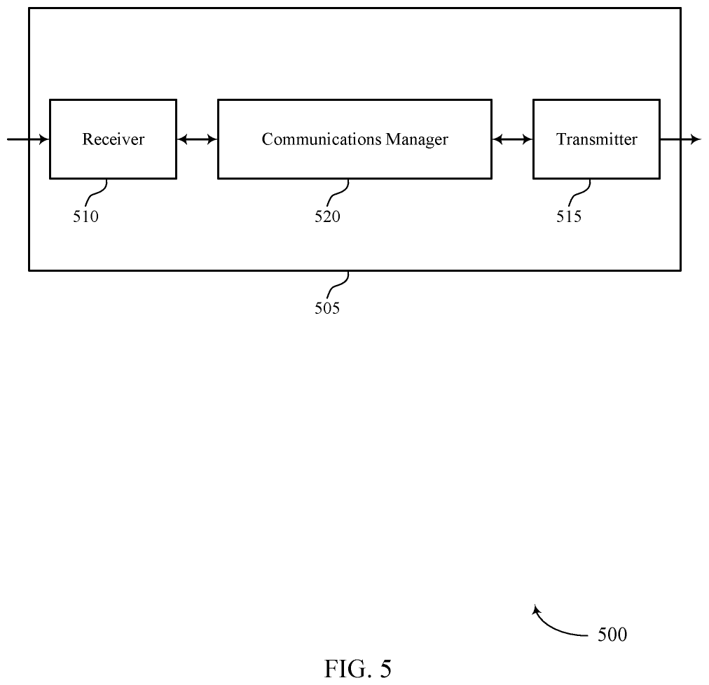

FIG. 5 shows a block diagram 500 of a device 505 that supports communication configurations for reduced power consumption in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to communication configurations for reduced power consumption). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to communication configurations for reduced power consumption). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of communication configurations for reduced power consumption as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving first control signaling that indicates a set of communication parameters for communications by the UE via a set of time and frequency resources, where the set of communication parameters support communications according to a first throughput, or at least a first processing timeline, or both. The communications manager 520 is capable of, configured to, or operable to support a means for receiving second control signaling that indicates a threshold throughput that is less than the first throughput, a threshold processing timeline that is longer than the first processing timeline, or both for communications by the UE. The communications manager 520 is capable of, configured to, or operable to support a means for communicating via the set of time and frequency resources in accordance with the set of communication parameters and the threshold throughput or the threshold processing timeline, or both.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption, more efficient utilization of communication resources, and the like.

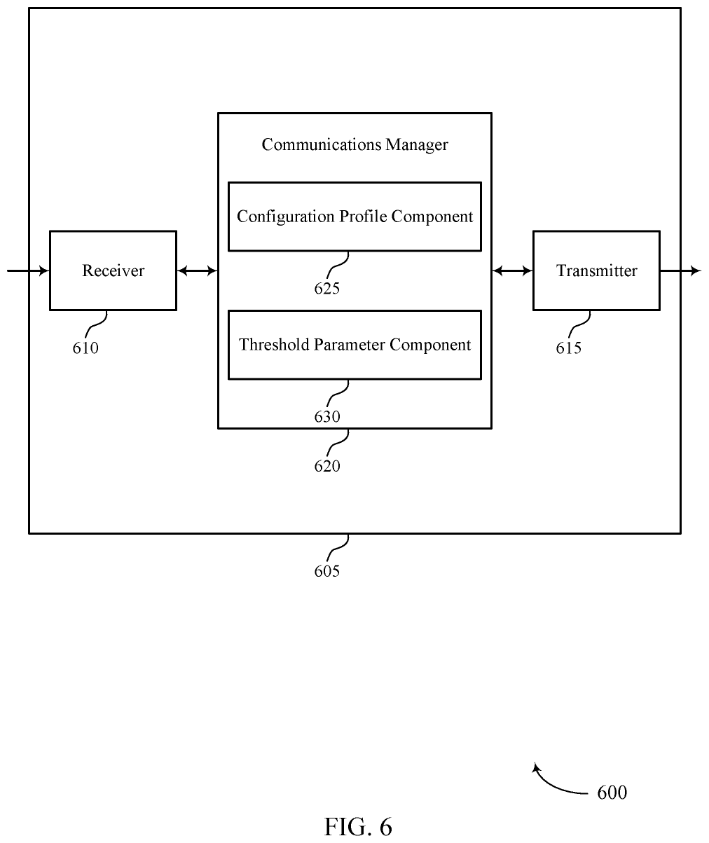

FIG. 6 shows a block diagram 600 of a device 605 that supports communication configurations for reduced power consumption in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to communication configurations for reduced power consumption). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to communication configurations for reduced power consumption). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of communication configurations for reduced power consumption as described herein. For example, the communications manager 620 may include a configuration profile component 625 a threshold parameter component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The configuration profile component 625 is capable of, configured to, or operable to support a means for receiving first control signaling that indicates a set of communication parameters for communications by the UE via a set of time and frequency resources, where the set of communication parameters support communications according to a first throughput, or at least a first processing timeline, or both. The threshold parameter component 630 is capable of, configured to, or operable to support a means for receiving second control signaling that indicates a threshold throughput that is less than the first throughput, a threshold processing timeline that is longer than the first processing timeline, or both for communications by the UE. The threshold parameter component 630 is capable of, configured to, or operable to support a means for communicating via the set of time and frequency resources in accordance with the set of communication parameters and the threshold throughput or the threshold processing timeline, or both.

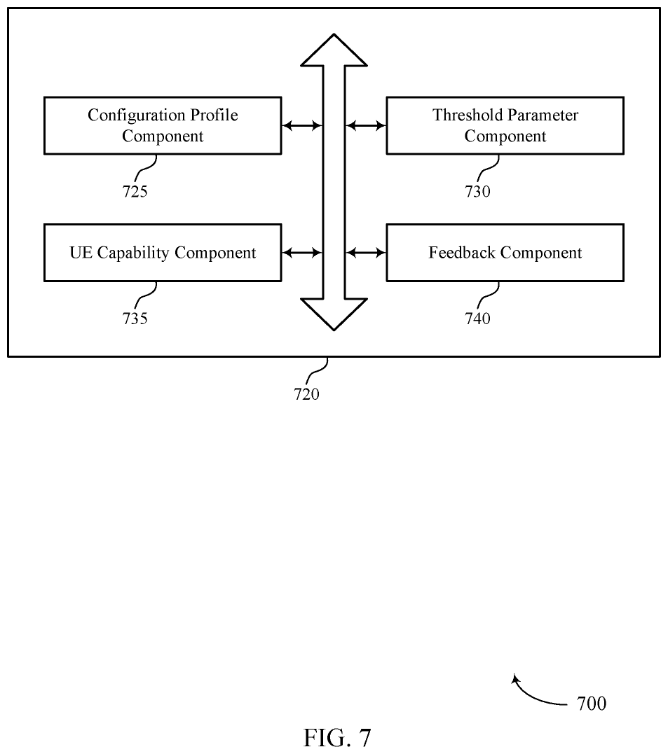

FIG. 7 shows a block diagram 700 of a communications manager 720 that supports communication configurations for reduced power consumption in accordance with one or more aspects of the present disclosure. The communications manager 720 may be an example of aspects of a communications manager 520, a communications manager 620, or both, as described herein. The communications manager 720, or various components thereof, may be an example of means for performing various aspects of communication configurations for reduced power consumption as described herein. For example, the communications manager 720 may include a configuration profile component 725, a threshold parameter component 730, a UE capability component 735, a feedback component 740, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The configuration profile component 725 is capable of, configured to, or operable to support a means for receiving first control signaling that indicates a set of communication parameters for communications by the UE via a set of time and frequency resources, where the set of communication parameters support communications according to a first throughput, or at least a first processing timeline, or both. The threshold parameter component 730 is capable of, configured to, or operable to support a means for receiving second control signaling that indicates a threshold throughput that is less than the first throughput, a threshold processing timeline that is longer than the first processing timeline, or both for communications by the UE. In some examples, the threshold parameter component 730 is capable of, configured to, or operable to support a means for communicating via the set of time and frequency resources in accordance with the set of communication parameters and the threshold throughput or the threshold processing timeline, or both.

In some examples, to support receiving the second control signaling, the threshold parameter component 730 is capable of, configured to, or operable to support a means for receiving, via the second control signaling, a scaling factor associated with the threshold throughput, the threshold processing timeline, or both, where the threshold throughput, the threshold processing timeline, or both are based on the scaling factor applied to the first throughput, or the first processing timeline, or both.

In some examples, to support receiving the second control signaling, the threshold parameter component 730 is capable of, configured to, or operable to support a means for receiving, via the second control signaling, a threshold TB size associated with a threshold time period, where the threshold throughput is based on the threshold TB size and the threshold time period.

In some examples, to support receiving the second control signaling, the threshold parameter component 730 is capable of, configured to, or operable to support a means for receiving, via the second control signaling, an indication of a first limited-buffer rate-matching value from among a set of multiple limited-buffer rate-matching values associated with the set of communication parameters, where the threshold throughput, the threshold processing timeline, or both are based on the first limited-buffer rate-matching value.

In some examples, to support receiving the second control signaling, the threshold parameter component 730 is capable of, configured to, or operable to support a means for receiving, via the second control signaling, an indication of a threshold quantity of consecutive transmission time intervals for communications by the UE, where the threshold throughput, the threshold processing timeline, or both are based on the threshold quantity of consecutive slots.

In some examples, the feedback component 740 is capable of, configured to, or operable to support a means for generating a feedback message according to a codebook, where a size of the codebook is based on the threshold quantity of consecutive transmission time intervals.

In some examples, the UE capability component 735 is capable of, configured to, or operable to support a means for transmitting a UE capability message that indicates a second throughput, a second processing timeline, or both that are supported by the UE, where the threshold throughput is less than or equal to the second throughput, the threshold processing timeline is greater than or equal to the second processing timeline, or both based on the UE capability message.

In some examples, the threshold parameter component 730 is capable of, configured to, or operable to support a means for receiving a control message including the first control signaling that indicates the set of communication parameters and the second control signaling that indicates the threshold throughput, the threshold processing timeline, or both for the communications by the UE, where the control message includes a DCI message, a MAC-control element, a BWP configuration message, a configuration profile message, an RRC message, or any combination thereof.

In some examples, to support receiving the second control signaling, the threshold parameter component 730 is capable of, configured to, or operable to support a means for receiving, via the second control signaling, a DCI message, a MAC-control element, or a RRC message that indicates the threshold throughput, the threshold processing timeline, or both for the communications by the UE.

In some examples, to support receiving the second control signaling, the threshold parameter component 730 is capable of, configured to, or operable to support a means for receiving, via the second control signaling, a SSSG configuration or a slot format indication message that indicates the threshold throughput, the threshold processing timeline, or both for the communications by the UE.

In some examples, the threshold throughput, the threshold processing timeline, or both apply to a single communication type from among a set of multiple communication types, the set of multiple communication types including multicast communications, broadcast communications, unicast communications, or any combination thereof.

In some examples, the threshold parameter component 730 is capable of, configured to, or operable to support a means for operating, based on the second control signaling, according to a first power configuration for the UE, where the first power configuration for the UE supports the threshold throughput, the threshold processing timeline, or both, and where the first power configuration for the UE consumes less power than a second power configuration for the UE that supports the first throughput supported by the set of communication parameters, the first processing timeline supported by the set of communication parameters, or both.

In some examples, the set of communication parameters include at least a rank, a bandwidth, a MCS, or a combination thereof.

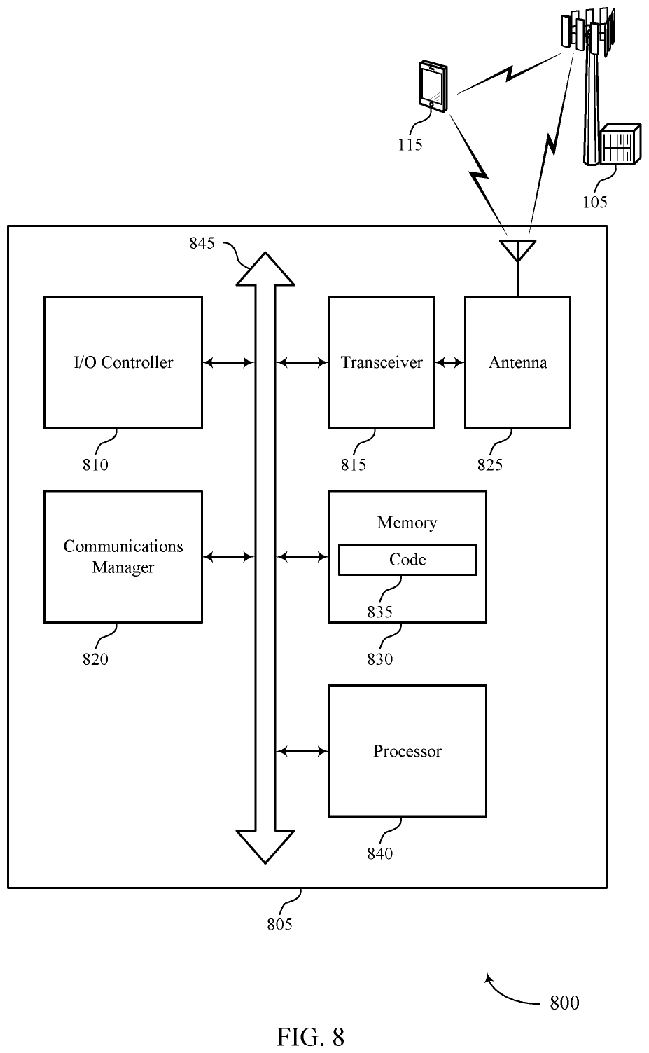

FIG. 8 shows a diagram of a system 800 including a device 805 that supports communication configurations for reduced power consumption in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICS, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting communication configurations for reduced power consumption). For example, the device 805 or a component of the device 805 may include at least one processor 840 and at least one memory 830 coupled with or to the at least one processor 840, the at least one processor 840 and the at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving first control signaling that indicates a set of communication parameters for communications by the UE via a set of time and frequency resources, where the set of communication parameters support communications according to a first throughput, or at least a first processing timeline, or both. The communications manager 820 is capable of, configured to, or operable to support a means for receiving second control signaling that indicates a threshold throughput that is less than the first throughput, a threshold processing timeline that is longer than the first processing timeline, or both for communications by the UE. The communications manager 820 is capable of, configured to, or operable to support a means for communicating via the set of time and frequency resources in accordance with the set of communication parameters and the threshold throughput or the threshold processing timeline, or both.

By including or configuring the communications manager 820 in accordance with examples as described herein, the device 805 may support techniques for reduced latency, reduced power consumption, more efficient utilization of communication resources, improved coordination between devices, longer battery life, improved utilization of processing capability, and the like.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of communication configurations for reduced power consumption as described herein, or the at least one processor 840 and the at least one memory 830 may be otherwise configured to, individually or collectively, perform or support such operations.

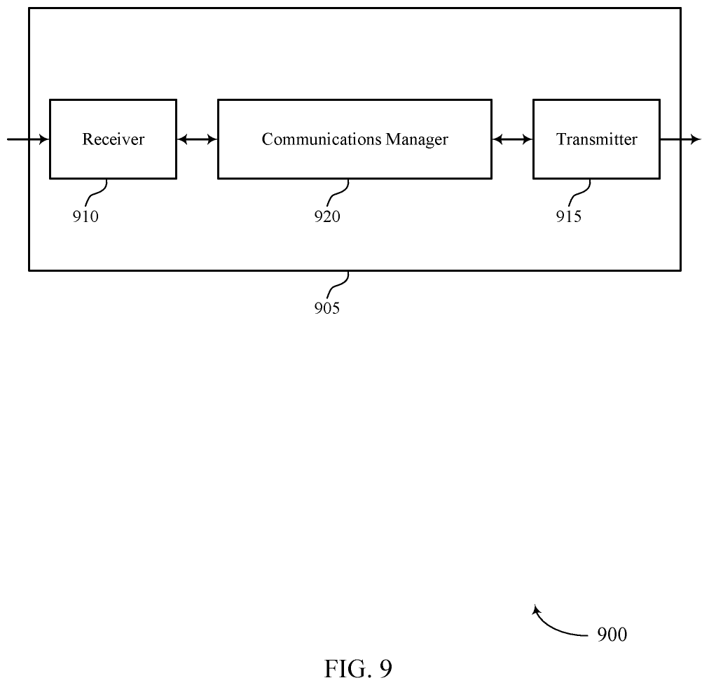

FIG. 9 shows a block diagram 900 of a device 905 that supports communication configurations for reduced power consumption in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of communication configurations for reduced power consumption as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for outputting first control signaling that indicates a set of communication parameters for communications by a UE via a set of time and frequency resources, where the set of communication parameters support communications according to a first throughput, or at least a first processing timeline, or both. The communications manager 920 is capable of, configured to, or operable to support a means for outputting second control signaling that indicates a threshold throughput that is less than the first throughput, a threshold processing timeline that is longer than the first processing timeline, or both for communications by the UE. The communications manager 920 is capable of, configured to, or operable to support a means for communicating via the set of time and frequency resources in accordance with the set of communication parameters and the threshold throughput or the threshold processing timeline, or both.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing, reduced power consumption, more efficient utilization of communication resources, and the like.

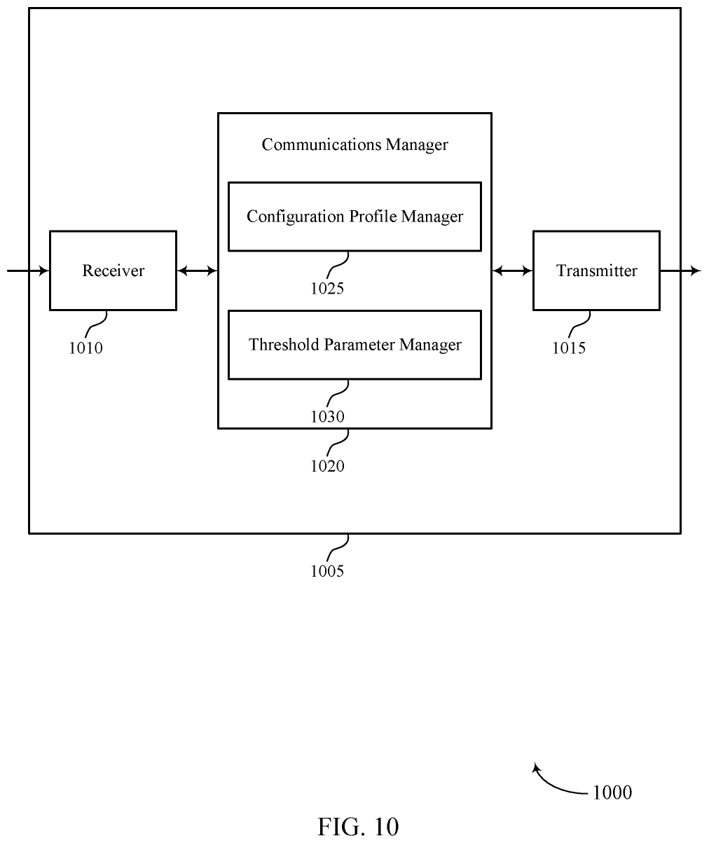

FIG. 10 shows a block diagram 1000 of a device 1005 that supports communication configurations for reduced power consumption in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of communication configurations for reduced power consumption as described herein. For example, the communications manager 1020 may include a configuration profile manager 1025 a threshold parameter manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The configuration profile manager 1025 is capable of, configured to, or operable to support a means for outputting first control signaling that indicates a set of communication parameters for communications by a UE via a set of time and frequency resources, where the set of communication parameters support communications according to a first throughput, or at least a first processing timeline, or both. The threshold parameter manager 1030 is capable of, configured to, or operable to support a means for outputting second control signaling that indicates a threshold throughput that is less than the first throughput, a threshold processing timeline that is longer than the first processing timeline, or both for communications by the UE. The threshold parameter manager 1030 is capable of, configured to, or operable to support a means for communicating via the set of time and frequency resources in accordance with the set of communication parameters and the threshold throughput or the threshold processing timeline, or both.

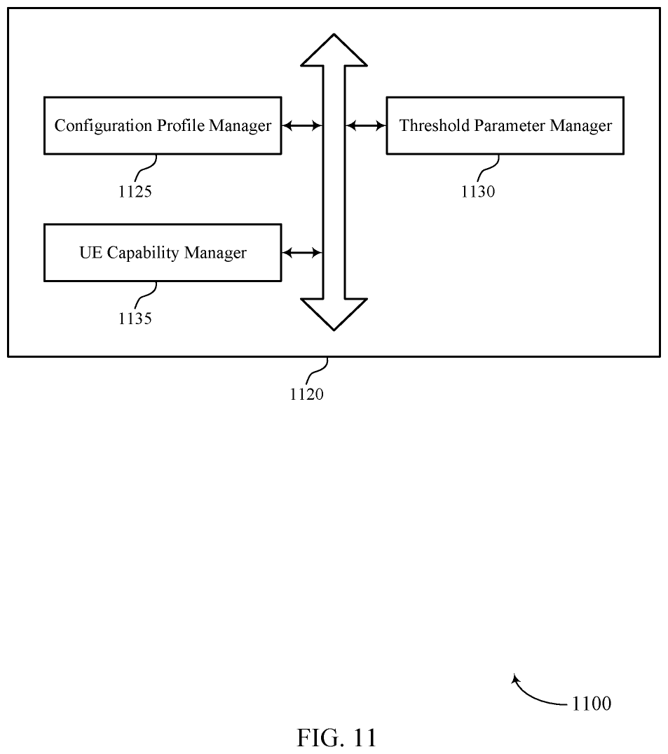

FIG. 11 shows a block diagram 1100 of a communications manager 1120 that supports communication configurations for reduced power consumption in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of communication configurations for reduced power consumption as described herein. For example, the communications manager 1120 may include a configuration profile manager 1125, a threshold parameter manager 1130, a UE capability manager 1135, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The configuration profile manager 1125 is capable of, configured to, or operable to support a means for outputting first control signaling that indicates a set of communication parameters for communications by a UE via a set of time and frequency resources, where the set of communication parameters support communications according to a first throughput, or at least a first processing timeline, or both. The threshold parameter manager 1130 is capable of, configured to, or operable to support a means for outputting second control signaling that indicates a threshold throughput that is less than the first throughput, a threshold processing timeline that is longer than the first processing timeline, or both for communications by the UE. In some examples, the threshold parameter manager 1130 is capable of, configured to, or operable to support a means for communicating via the set of time and frequency resources in accordance with the set of communication parameters and the threshold throughput or the threshold processing timeline, or both.

In some examples, to support outputting the second control signaling, the threshold parameter manager 1130 is capable of, configured to, or operable to support a means for outputting, via the second control signaling, a scaling factor associated with the threshold throughput, the threshold processing timeline, or both, where the threshold throughput, the threshold processing timeline, or both are based on the scaling factor applied to the first throughput, or the first processing timeline, or both.

In some examples, to support outputting the second control signaling, the threshold parameter manager 1130 is capable of, configured to, or operable to support a means for outputting, via the second control signaling, a threshold TB size associated with a threshold time period, where the threshold throughput is based on the threshold TB size and the threshold time period.

In some examples, to support outputting the second control signaling, the threshold parameter manager 1130 is capable of, configured to, or operable to support a means for outputting, via the second control signaling, an indication of a first limited-buffer rate-matching value from among a set of multiple limited-buffer rate-matching values associated with the set of communication parameters, where the threshold throughput, the threshold processing timeline, or both are based on the first limited-buffer rate-matching value.

In some examples, to support outputting the second control signaling, the threshold parameter manager 1130 is capable of, configured to, or operable to support a means for outputting, via the second control signaling, an indication of a threshold quantity of consecutive transmission time intervals for communications by the UE, where the threshold throughput, the threshold processing timeline, or both are based on the threshold quantity of consecutive slots.

In some examples, the UE capability manager 1135 is capable of, configured to, or operable to support a means for obtaining a UE capability message that indicates a second throughput, a second processing timeline, or both that are supported by the UE, where the threshold throughput is less than or equal to the second throughput, the threshold processing timeline is greater than or equal to the second processing timeline, or both based on the UE capability message.

In some examples, the threshold parameter manager 1130 is capable of, configured to, or operable to support a means for outputting a control message including the first control signaling that indicates the set of communication parameters and the second control signaling that indicates the threshold throughput, the threshold processing timeline, or both for the communications by the UE, where the control message includes a DCI message, a MAC-control element, a BWP configuration message, a configuration profile message, an RRC message, or any combination thereof.

In some examples, to support outputting the second control signaling, the threshold parameter manager 1130 is capable of, configured to, or operable to support a means for outputting, via the second control signaling, a DCI message, a MAC-control element, or a RRC message that indicates the threshold throughput, the threshold processing timeline, or both for the communications by the UE.

In some examples, to support outputting the second control signaling, the threshold parameter manager 1130 is capable of, configured to, or operable to support a means for outputting, via the second control signaling, a SSSG configuration or a slot format indication message that indicates the threshold throughput, the threshold processing timeline, or both for the communications by the UE.

In some examples, the threshold throughput, the threshold processing timeline, or both apply to a single communication type from among a set of multiple communication types, the set of multiple communication types including multicast communications, broadcast communications, unicast communications, or any combination thereof.

In some examples, the set of communication parameters include at least a rank, a bandwidth, a MCS, or a combination thereof.

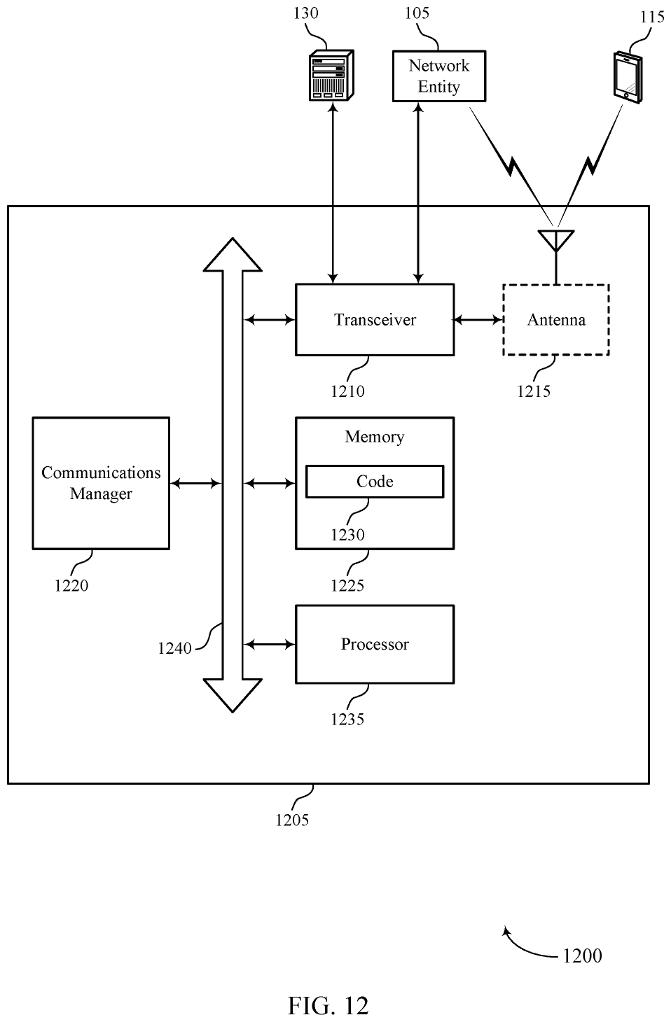

FIG. 12 shows a diagram of a system 1200 including a device 1205 that supports communication configurations for reduced power consumption in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting communication configurations for reduced power consumption). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225). In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network devices, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for outputting first control signaling that indicates a set of communication parameters for communications by a UE via a set of time and frequency resources, where the set of communication parameters support communications according to a first throughput, or at least a first processing timeline, or both. The communications manager 1220 is capable of, configured to, or operable to support a means for outputting second control signaling that indicates a threshold throughput that is less than the first throughput, a threshold processing timeline that is longer than the first processing timeline, or both for communications by the UE. The communications manager 1220 is capable of, configured to, or operable to support a means for communicating via the set of time and frequency resources in accordance with the set of communication parameters and the threshold throughput or the threshold processing timeline, or both.

By including or configuring the communications manager 1220 in accordance with examples as described herein, the device 1205 may support techniques for reduced latency, reduced power consumption, more efficient utilization of communication resources, improved coordination between devices, longer battery life, improved utilization of processing capability, and the like.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of communication configurations for reduced power consumption as described herein, or the at least one processor 1235 and the at least one memory 1225 may be otherwise configured to, individually or collectively, perform or support such operations.

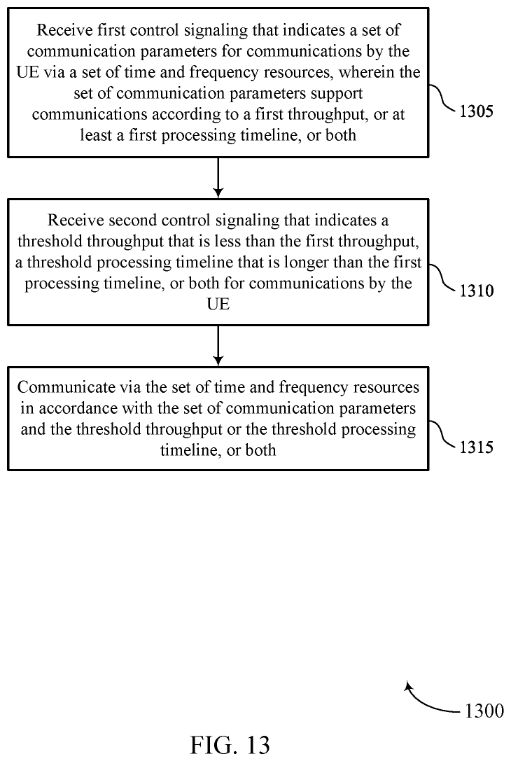

FIG. 13 shows a flowchart illustrating a method 1300 that supports communication configurations for reduced power consumption in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving first control signaling that indicates a set of communication parameters for communications by the UE via a set of time and frequency resources, wherein the set of communication parameters support communications according to a first throughput, or at least a first processing timeline, or both. The operations of 1305 may be performed in accordance with examples as disclosed herein. In some examples, aspects of the operations of 1305 may be performed by a configuration profile component 725 as described with reference to FIG. 7.

At 1310, the method may include receiving second control signaling that indicates a threshold throughput that is less than the first throughput, a threshold processing timeline that is longer than the first processing timeline, or both for communications by the UE. The operations of 1310 may be performed in accordance with examples as disclosed herein. In some examples, aspects of the operations of 1310 may be performed by a threshold parameter component 730 as described with reference to FIG. 7.

At 1315, the method may include communicating via the set of time and frequency resources in accordance with the set of communication parameters and the threshold throughput or the threshold processing timeline, or both. The operations of 1315 may be performed in accordance with examples as disclosed herein. In some examples, aspects of the operations of 1315 may be performed by a threshold parameter component 730 as described with reference to FIG. 7.

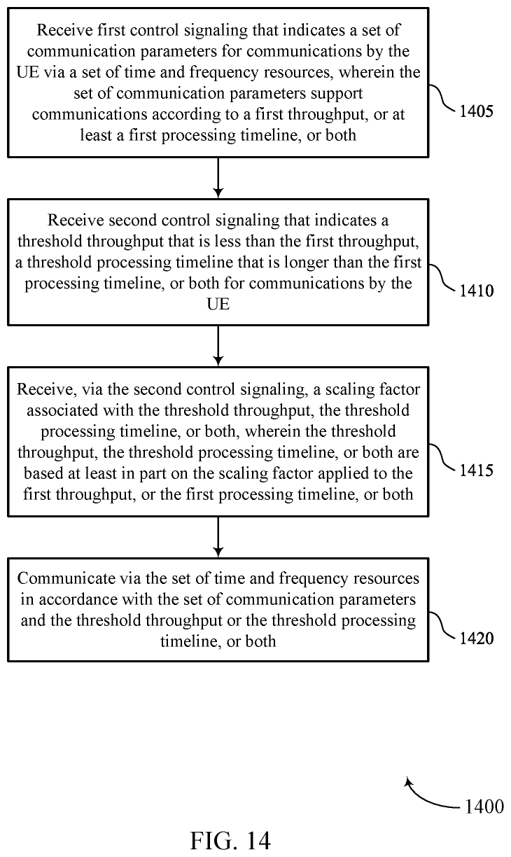

FIG. 14 shows a flowchart illustrating a method 1400 that supports communication configurations for reduced power consumption in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving first control signaling that indicates a set of communication parameters for communications by the UE via a set of time and frequency resources, wherein the set of communication parameters support communications according to a first throughput, or at least a first processing timeline, or both. The operations of 1405 may be performed in accordance with examples as disclosed herein. In some examples, aspects of the operations of 1405 may be performed by a configuration profile component 725 as described with reference to FIG. 7.

At 1410, the method may include receiving second control signaling that indicates a threshold throughput that is less than the first throughput, a threshold processing timeline that is longer than the first processing timeline, or both for communications by the UE. The operations of 1410 may be performed in accordance with examples as disclosed herein. In some examples, aspects of the operations of 1410 may be performed by a threshold parameter component 730 as described with reference to FIG. 7.

At 1415, the method may include receiving, via the second control signaling, a scaling factor associated with the threshold throughput, the threshold processing timeline, or both, wherein the threshold throughput, the threshold processing timeline, or both are based at least in part on the scaling factor applied to the first throughput, or the first processing timeline, or both. The operations of 1415 may be performed in accordance with examples as disclosed herein. In some examples, aspects of the operations of 1415 may be performed by a threshold parameter component 730 as described with reference to FIG. 7.

At 1420, the method may include communicating via the set of time and frequency resources in accordance with the set of communication parameters and the threshold throughput or the threshold processing timeline, or both. The operations of 1420 may be performed in accordance with examples as disclosed herein. In some examples, aspects of the operations of 1420 may be performed by a threshold parameter component 730 as described with reference to FIG. 7.

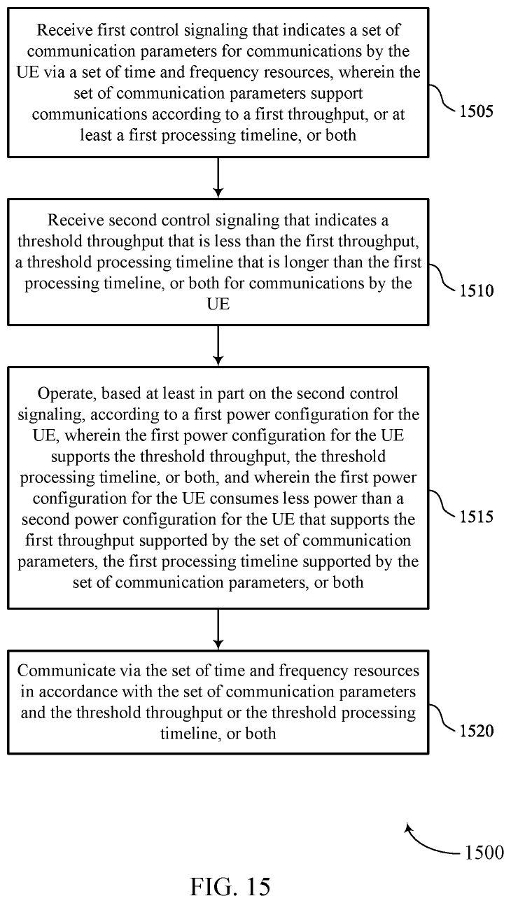

FIG. 15 shows a flowchart illustrating a method 1500 that supports communication configurations for reduced power consumption in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include receiving first control signaling that indicates a set of communication parameters for communications by the UE via a set of time and frequency resources, wherein the set of communication parameters support communications according to a first throughput, or at least a first processing timeline, or both. The operations of 1505 may be performed in accordance with examples as disclosed herein. In some examples, aspects of the operations of 1505 may be performed by a configuration profile component 725 as described with reference to FIG. 7.

At 1510, the method may include receiving second control signaling that indicates a threshold throughput that is less than the first throughput, a threshold processing timeline that is longer than the first processing timeline, or both for communications by the UE. The operations of 1510 may be performed in accordance with examples as disclosed herein. In some examples, aspects of the operations of 1510 may be performed by a threshold parameter component 730 as described with reference to FIG. 7.

At 1515, the method may include operating, based at least in part on the second control signaling, according to a first power configuration for the UE, wherein the first power configuration for the UE supports the threshold throughput, the threshold processing timeline, or both, and wherein the first power configuration for the UE consumes less power than a second power configuration for the UE that supports the first throughput supported by the set of communication parameters, the first processing timeline supported by the set of communication parameters, or both. The operations of 1520 may be performed in accordance with examples as disclosed herein. In some examples, aspects of the operations of 1520 may be performed by a threshold parameter component 730 as described with reference to FIG. 7.

At 1520, the method may include communicating via the set of time and frequency resources in accordance with the set of communication parameters and the threshold throughput or the threshold processing timeline, or both. The operations of 1515 may be performed in accordance with examples as disclosed herein. In some examples, aspects of the operations of 1515 may be performed by a threshold parameter component 730 as described with reference to FIG. 7.

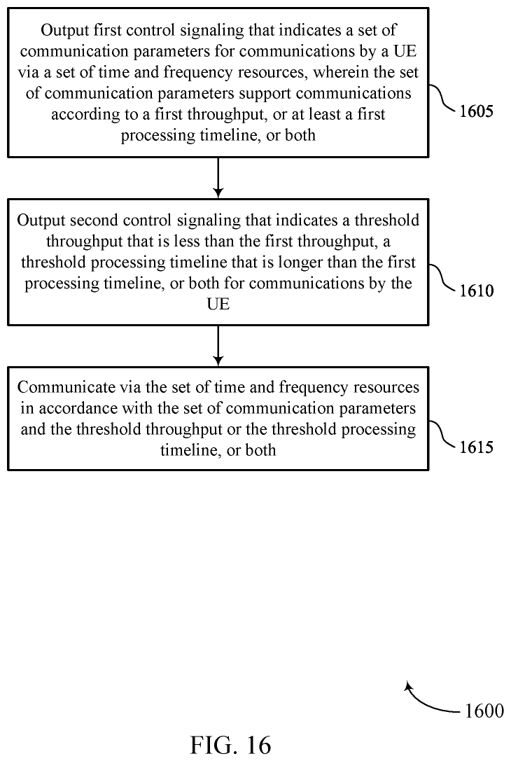

FIG. 16 shows a flowchart illustrating a method 1600 that supports communication configurations for reduced power consumption in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include outputting first control signaling that indicates a set of communication parameters for communications by a UE via a set of time and frequency resources, wherein the set of communication parameters support communications according to a first throughput, or at least a first processing timeline, or both. The operations of 1605 may be performed in accordance with examples as disclosed herein. In some examples, aspects of the operations of 1605 may be performed by a configuration profile manager 1125 as described with reference to FIG. 11.

At 1610, the method may include outputting second control signaling that indicates a threshold throughput that is less than the first throughput, a threshold processing timeline that is longer than the first processing timeline, or both for communications by the UE. The operations of 1610 may be performed in accordance with examples as disclosed herein. In some examples, aspects of the operations of 1610 may be performed by a threshold parameter manager 1130 as described with reference to FIG. 11.

At 1615, the method may include communicating via the set of time and frequency resources in accordance with the set of communication parameters and the threshold throughput or the threshold processing timeline, or both. The operations of 1615 may be performed in accordance with examples as disclosed herein. In some examples, aspects of the operations of 1615 may be performed by a threshold parameter manager 1130 as described with reference to FIG. 11.

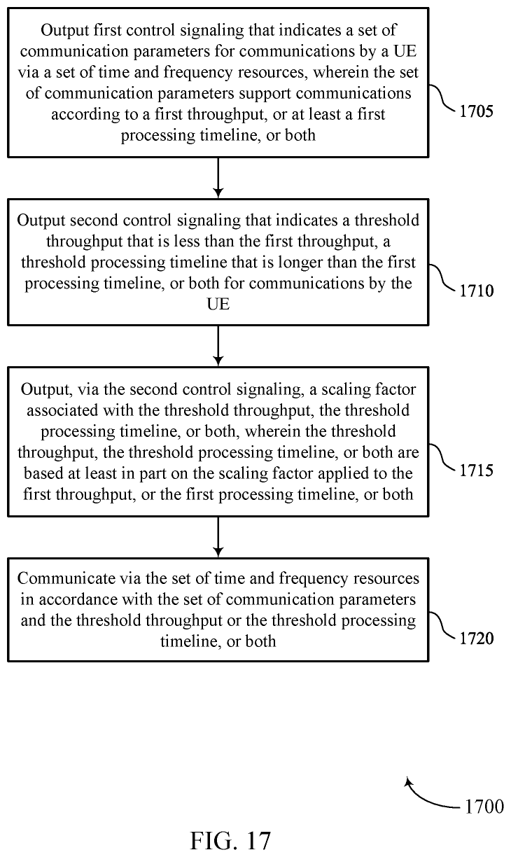

FIG. 17 shows a flowchart illustrating a method 1700 that supports communication configurations for reduced power consumption in accordance with one or more aspects of the present disclosure. The operations of the method 1700 may be implemented by a network entity or its components as described herein. For example, the operations of the method 1700 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1705, the method may include outputting first control signaling that indicates a set of communication parameters for communications by a UE via a set of time and frequency resources, wherein the set of communication parameters support communications according to a first throughput, or at least a first processing timeline, or both. The operations of 1705 may be performed in accordance with examples as disclosed herein. In some examples, aspects of the operations of 1705 may be performed by a configuration profile manager 1125 as described with reference to FIG. 11.

At 1710, the method may include outputting second control signaling that indicates a threshold throughput that is less than the first throughput, a threshold processing timeline that is longer than the first processing timeline, or both for communications by the UE. The operations of 1710 may be performed in accordance with examples as disclosed herein. In some examples, aspects of the operations of 1710 may be performed by a threshold parameter manager 1130 as described with reference to FIG. 11.

At 1715, the method may include outputting, via the second control signaling, a scaling factor associated with the threshold throughput, the threshold processing timeline, or both, wherein the threshold throughput, the threshold processing timeline, or both are based at least in part on the scaling factor applied to the first throughput, or the first processing timeline, or both. The operations of 1715 may be performed in accordance with examples as disclosed herein. In some examples, aspects of the operations of 1715 may be performed by a threshold parameter manager 1130 as described with reference to FIG. 11.

At 1720, the method may include communicating via the set of time and frequency resources in accordance with the set of communication parameters and the threshold throughput or the threshold processing timeline, or both. The operations of 1720 may be performed in accordance with examples as disclosed herein. In some examples, aspects of the operations of 1720 may be performed by a threshold parameter manager 1130 as described with reference to FIG. 11.

The following provides an overview of aspects of the present disclosure:

Aspect 1: A method for wireless communications at a UE, comprising: receiving first control signaling that indicates a set of communication parameters for communications by the UE via a set of time and frequency resources, wherein the set of communication parameters support communications according to a first throughput, or at least a first processing timeline, or both; receiving second control signaling that indicates a threshold throughput that is less than the first throughput, a threshold processing timeline that is longer than the first processing timeline, or both for communications by the UE; and communicating via the set of time and frequency resources in accordance with the set of communication parameters and the threshold throughput or the threshold processing timeline, or both.

Aspect 2: The method of aspect 1, wherein receiving the second control signaling comprises: receiving, via the second control signaling, a scaling factor associated with the threshold throughput, the threshold processing timeline, or both, wherein the threshold throughput, the threshold processing timeline, or both are based at least in part on the scaling factor applied to the first throughput, or the first processing timeline, or both.

Aspect 3: The method of aspect 1, wherein receiving the second control signaling comprises: receiving, via the second control signaling, a threshold TB size associated with a threshold time period, wherein the threshold throughput is based at least in part on the threshold TB size and the threshold time period.

Aspect 4: The method of aspect 1, wherein receiving the second control signaling comprises: receiving, via the second control signaling, an indication of a first LBRM value from among a plurality of LBRM values associated with the set of communication parameters, wherein the threshold throughput, the threshold processing timeline, or both are based at least in part on the first LBRM value.

Aspect 5: The method of aspect 1, wherein receiving the second control signaling comprises: receiving, via the second control signaling, an indication of a threshold quantity of consecutive TTIs for communications by the UE, wherein the threshold throughput, the threshold processing timeline, or both are based at least in part on the threshold quantity of consecutive slots.

Aspect 6: The method of aspect 5, further comprising: generating a feedback message according to a codebook, wherein a size of the codebook is based at least in part on the threshold quantity of consecutive TTIs.

Aspect 7: The method of any of aspects 1 through 6, further comprising: transmitting a UE capability message that indicates a second throughput, a second processing timeline, or both that are supported by the UE, wherein the threshold throughput is less than or equal to the second throughput, the threshold processing timeline is greater than or equal to the second processing timeline, or both based at least in part on the UE capability message.

Aspect 8: The method of any of aspects 1 through 7, further comprising: receiving a control message comprising the first control signaling that indicates the set of communication parameters and the second control signaling that indicates the threshold throughput, the threshold processing timeline, or both for the communications by the UE, wherein the control message comprises a DCI message, a MAC-CE, a BWP configuration message, a configuration profile message, a RRC message, or any combination thereof.

Aspect 9: The method of any of aspects 1 through 7, wherein receiving the second control signaling comprises: receiving, via the second control signaling, a DCI message, a MAC-CE, or a RRC message that indicates the threshold throughput, the threshold processing timeline, or both for the communications by the UE.

Aspect 10: The method of any of aspects 1 and 6 through 9, wherein receiving the second control signaling comprises: receiving, via the second control signaling, a SSSG configuration or a slot format indication message that indicates the threshold throughput, the threshold processing timeline, or both for the communications by the UE.

Aspect 11: The method of any of aspects 1 through 10, wherein the threshold throughput, the threshold processing timeline, or both apply to a single communication type from among a plurality of communication types, the plurality of communication types comprising multicast communications, broadcast communications, unicast communications, or any combination thereof.

Aspect 12: The method of any of aspects 1 through 11, further comprising: operating, based at least in part on the second control signaling, according to a first power configuration for the UE, wherein the first power configuration for the UE supports the threshold throughput, the threshold processing timeline, or both, and wherein the first power configuration for the UE consumes less power than a second power configuration for the UE that supports the first throughput supported by the set of communication parameters, the first processing timeline supported by the set of communication parameters, or both.

Aspect 13: The method of any of aspects 1 through 12, wherein the set of communication parameters comprise at least a rank, a bandwidth, a MCS, or a combination thereof.

Aspect 14: A method for wireless communication at a network entity, comprising: output first control signaling that indicates a set of communication parameters for communications by a UE via a set of time and frequency resources, wherein the set of communication parameters support communications according to a first throughput, or at least a first processing timeline, or both; output second control signaling that indicates a threshold throughput that is less than the first throughput, a threshold processing timeline that is longer than the first processing timeline, or both for communications by the UE; and communicating via the set of time and frequency resources in accordance with the set of communication parameters and the threshold throughput or the threshold processing timeline, or both.

Aspect 15: The method of aspect 14, wherein outputting the second control signaling comprises: output, via the second control signaling, a scaling factor associated with the threshold throughput, the threshold processing timeline, or both, wherein the threshold throughput, the threshold processing timeline, or both are based at least in part on the scaling factor applied to the first throughput, or the first processing timeline, or both.

Aspect 16: The method of aspect 14, wherein outputting the second control signaling comprises: output, via the second control signaling, a threshold TB size associated with a threshold time period, wherein the threshold throughput is based at least in part on the threshold TB size and the threshold time period.

Aspect 17: The method of aspect 14, wherein outputting the second control signaling comprises: output, via the second control signaling, an indication of a first LBRM value from among a plurality of LBRM values associated with the set of communication parameters, wherein the threshold throughput, the threshold processing timeline, or both are based at least in part on the first LBRM value.

Aspect 18: The method of aspect 14, wherein outputting the second control signaling comprises: output, via the second control signaling, an indication of a threshold quantity of consecutive TTIs for communications by the UE, wherein the threshold throughput, the threshold processing timeline, or both are based at least in part on the threshold quantity of consecutive slots.

Aspect 19: A UE comprising one or more memories storing processor-executable code, and one or more processors coupled with the one or more memories and individually or collectively operable to execute the code to cause the UE to perform a method of any of aspects 1 through 13.

Aspect 20: A UE comprising at least one means for performing a method of any of aspects 1 through 13.

Aspect 21: A non-transitory computer-readable medium storing code the code comprising instructions executable by one or more processors to perform a method of any of aspects 1 through 13.

Aspect 22: A network entity comprising one or more memories storing processor-executable code, and one or more processors coupled with the one or more memories and individually or collectively operable to execute the code to cause the network entity to perform a method of any of aspects 14 through 18.

Aspect 23: A network entity comprising at least one means for performing a method of any of aspects 14 through 18.

Aspect 24: A non-transitory computer-readable medium storing code the code comprising instructions executable by one or more processors to perform a method of any of aspects 14 through 18.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive first control signaling that indicates a set of communication parameters for communications by the UE via a set of time and frequency resources, wherein the set of communication parameters support communications according to a first throughput, or at least a first processing timeline, or both;
receive second control signaling that indicates a threshold throughput that is less than the first throughput, a threshold processing timeline that is longer than the first processing timeline, or both for communications by the UE; and
communicate via the set of time and frequency resources in accordance with the set of communication parameters and the threshold throughput or the threshold processing timeline, or both.

2. The UE of claim 1, wherein, to receive the second control signaling, the one or more processors are individually or collectively operable to execute the code to cause the UE to:
receive, via the second control signaling, a scaling factor associated with the threshold throughput, the threshold processing timeline, or both, wherein the threshold throughput, the threshold processing timeline, or both are based at least in part on the scaling factor applied to the first throughput, or the first processing timeline, or both.

3. The UE of claim 1, wherein, to receive the second control signaling, the one or more processors are individually or collectively operable to execute the code to cause the UE to:
receive, via the second control signaling, a threshold transport block size associated with a threshold time period, wherein the threshold throughput is based at least in part on the threshold transport block size and the threshold time period.

4. The UE of claim 1, wherein, to receive the second control signaling, the one or more processors are individually or collectively operable to execute the code to cause the UE to:
receive, via the second control signaling, an indication of a first limited-buffer rate-matching value from among a plurality of limited-buffer rate-matching values associated with the set of communication parameters, wherein the threshold throughput, the threshold processing timeline, or both are based at least in part on the first limited-buffer rate-matching value.

5. The UE of claim 1, wherein, to receive the second control signaling, the one or more processors are individually or collectively operable to execute the code to cause the UE to:
receive, via the second control signaling, an indication of a threshold quantity of consecutive transmission time intervals for communications by the UE, wherein the threshold throughput, the threshold processing timeline, or both are based at least in part on the threshold quantity of consecutive slots.

6. The UE of claim 5, wherein the one or more processors are individually or collectively further operable to execute the code to cause the UE to:
generate a feedback message according to a codebook, wherein a size of the codebook is based at least in part on the threshold quantity of consecutive transmission time intervals.

7. The UE of claim 1, wherein the one or more processors are individually or collectively further operable to execute the code to cause the UE to:
transmit a UE capability message that indicates a second throughput, a second processing timeline, or both that are supported by the UE, wherein the threshold throughput is less than or equal to the second throughput, the threshold processing timeline is greater than or equal to the second processing timeline, or both based at least in part on the UE capability message.

8. The UE of claim 1, wherein the one or more processors are individually or collectively further operable to execute the code to cause the UE to:
receive a control message comprising the first control signaling that indicates the set of communication parameters and the second control signaling that indicates the threshold throughput, the threshold processing timeline, or both for the communications by the UE, wherein the control message comprises a downlink control information message, a medium access control-control element, a bandwidth part configuration message, a configuration profile message, a radio resource control message, or any combination thereof.

9. The UE of claim 1, wherein, to receive the second control signaling, the one or more processors are individually or collectively operable to execute the code to cause the UE to:
receive, via the second control signaling, a downlink control information message, a medium access control-control element, or a radio resource control message that indicates the threshold throughput, the threshold processing timeline, or both for the communications by the UE.

10. The UE of claim 1, wherein, to receive the second control signaling, the one or more processors are individually or collectively operable to execute the code to cause the UE to:
receive, via the second control signaling, a search space set group configuration or a slot format indication message that indicates the threshold throughput, the threshold processing timeline, or both for the communications by the UE.

11. The UE of claim 1, wherein the threshold throughput, the threshold processing timeline, or both apply to a single communication type from among a plurality of communication types, the plurality of communication types comprising multicast communications, broadcast communications, unicast communications, or any combination thereof.

12. The UE of claim 1, wherein the one or more processors are individually or collectively further operable to execute the code to cause the UE to:
operate, based at least in part on the second control signaling, according to a first power configuration for the UE, wherein the first power configuration for the UE supports the threshold throughput, the threshold processing timeline, or both, and wherein the first power configuration for the UE consumes less power than a second power configuration for the UE that supports the first throughput supported by the set of communication parameters, the first processing timeline supported by the set of communication parameters, or both.

13. The UE of claim 1, wherein the set of communication parameters comprise at least a rank, a bandwidth, a modulation and coding scheme, or a combination thereof.

14. A network entity, comprising:
one or more memories storing processor-executable code; and
one or more processors coupled with the one or more memories and individually or collectively operable to execute the code to cause the network entity to:
output first control signaling that indicates a set of communication parameters for communications by a user equipment (UE) via a set of time and frequency resources, wherein the set of communication parameters support communications according to a first throughput, or at least a first processing timeline, or both;
output second control signaling that indicates a threshold throughput that is less than the first throughput, a threshold processing timeline that is longer than the first processing timeline, or both for communications by the UE; and
communicate via the set of time and frequency resources in accordance with the set of communication parameters and the threshold throughput or the threshold processing timeline, or both.

15. The network entity of claim 14, wherein, to output the second control signaling, the one or more processors are individually or collectively operable to execute the code to cause the network entity to:
output, via the second control signaling, a scaling factor associated with the threshold throughput, the threshold processing timeline, or both, wherein the threshold throughput, the threshold processing timeline, or both are based at least in part on the scaling factor applied to the first throughput, or the first processing timeline, or both.

16. The network entity of claim 14, wherein, to output the second control signaling, the one or more processors are individually or collectively operable to execute the code to cause the network entity to:
output, via the second control signaling, a threshold transport block size associated with a threshold time period, wherein the threshold throughput is based at least in part on the threshold transport block size and the threshold time period.

17. The network entity of claim 14, wherein, to output the second control signaling, the one or more processors are individually or collectively operable to execute the code to cause the network entity to:
output, via the second control signaling, an indication of a first limited-buffer rate-matching value from among a plurality of limited-buffer rate-matching values associated with the set of communication parameters, wherein the threshold throughput, the threshold processing timeline, or both are based at least in part on the first limited-buffer rate-matching value.

18. The network entity of claim 14, wherein, to output the second control signaling, the one or more processors are individually or collectively operable to execute the code to cause the network entity to:
output, via the second control signaling, an indication of a threshold quantity of consecutive transmission time intervals for communications by the UE, wherein the threshold throughput, the threshold processing timeline, or both are based at least in part on the threshold quantity of consecutive slots.

19. A method for wireless communications at a user equipment (UE), comprising:
receiving first control signaling that indicates a set of communication parameters for communications by the UE via a set of time and frequency resources, wherein the set of communication parameters support communications according to a first throughput, or at least a first processing timeline, or both;
receiving second control signaling that indicates a threshold throughput that is less than the first throughput, a threshold processing timeline that is longer than the first processing timeline, or both for communications by the UE; and
communicating via the set of time and frequency resources in accordance with the set of communication parameters and the threshold throughput or the threshold processing timeline, or both.

20. The method of claim 19, wherein receiving the second control signaling comprises:
receiving, via the second control signaling, a scaling factor associated with the threshold throughput, the threshold processing timeline, or both, wherein the threshold throughput, the threshold processing timeline, or both are based at least in part on the scaling factor applied to the first throughput, or the first processing timeline, or both.
